(19) United States
(12) Patent Application Publication
(10) Pub. No.: US 2023/0051724 A1
(43) Pub. Date: Feb. 16, 2023

(54) STRENGTHENED GLASS ARTICLES AND CONSUMER ELECTRONIC PRODUCTS INCLUDING THE SAME

(71) Applicant: CORNING INCORPORATED, CORNING, NY (US)

(72) Inventors: Timothy Michael Gross, Painted Post, NY (US); Jeffrey Todd Kohli, Corning, NY (US); Peter Joseph Lezzi, Corning, NY (US); Vitor Marino Schneider, Painted Post, NY (US); Jingshi Wu, Painted Post, NY (US); Zheming Zheng, Horseheads, NY (US)

(21) Appl. No.: 17/788,997

(22) PCT Filed: Dec. 30, 2020
(86) PCT No.: PCT/US2020/067393

§ 371 Date: Jun. 24, 2022

Related U.S. Application Data
(60) Provisional application No. 62/956,922, filed on Jan. 3, 2020.

(51) Int. Cl. C03C 21/00; C03C 23/00; C03C 4/16; B32B 17/10

(52) U.S. Cl. CPC C03C 21/002; C03C 23/007; C03C 4/16; B32B 17/10091; B32B 17/10137; B32B 2457/20

(57) ABSTRACT

Strengthened glass articles formed from a glass composition comprising less than 1.0 mol % R₂O, where R is an alkali ion, are disclosed. In various embodiments, the glass articles have a dielectric constant of less than 6.25 and a dielectric loss tangent of less than 0.01 at 30 GHz. Electronic devices, such as consumer electronic products, including the strengthened glass articles, as well as methods of making the strengthened glass articles are also disclosed.

This application claims the benefit of priority under 35 U.S.C. § 119 of U.S. Provisional Application Ser. No. 62/956,922 filed on Jan. 3, 2020, the contents of which is relied upon and incorporated herein by reference in its entirety.

### FIELD

The present disclosure relates generally to strengthened glass articles and methods for producing the same and, more particularly, to strengthened glass articles with low dielectric constants and low dielectric loss tangents at 30 GHz and methods for producing the same.

### BACKGROUND

Wireless communications are moving to higher frequency bands in the millimeter wavelength regime in order to increase data rates, reduce latency, and improve the cost of communications. In particular, the move from 4G to 5G wireless communications means a move from communication bands in the range of from about 700 MHz-3 GHz to communication bands in the range of 20 GHz-100 GHz. However, many of the materials used in electronic devices have poor transmission or dielectric permeability in this wave region.

In mobile electronic devices, metal device backs have already been replaced with glass or other non-metallic materials in order to facilitate permeability or transmission of antenna signals. However, it is expected that glass conventionally used in mobile electronic devices, such as is used for covers and device backs, will impede transmission and reception of data signals.

Accordingly, the need exists for strengthened glass articles having low dielectric constant and low dielectric loss tangent in the range of 20 GHz-100 GHz, and more specifically, from 25 GHz-40 GHz.

### SUMMARY

According to a first aspect disclosed herein, a strengthened glass article is formed from a glass composition comprising less than 1.0 mol % R₂O, where R is an alkali ion, wherein the strengthened glass article has a dielectric constant of less than 6.25 and a dielectric loss tangent of less than 0.01 at 30 GHz.

According to a second aspect disclosed herein, a strengthened glass article includes the strengthened glass article according to the first aspect, wherein the strengthened glass article has a thermal conductivity of from 1.0 to 1.5 W/m*K at 25° C.

According to a third aspect disclosed herein, a strengthened glass article includes the strengthened glass article according to any one of the previous aspects, wherein the strengthened glass article has a dielectric constant of from 2 to 6 at 30 GHz.

According to a fourth aspect disclosed herein, a strengthened glass article includes the strengthened glass article according to any one of the previous aspects, wherein the strengthened glass article has a dielectric loss tangent of from 0.0001 to 0.01 at 30 GHz.

According to a fifth aspect disclosed herein, a strengthened glass article includes the strengthened glass article according to any one of the previous aspects, wherein the glass composition is selected from the group consisting of a silicate glass composition, a borate glass composition, a phosphate glass composition, an aluminate glass composition, a germanate glass composition, and combinations thereof.

According to a sixth aspect disclosed herein, a strengthened glass article includes the strengthened glass article according to any one of the previous aspects, wherein the glass composition comprises less than 0.1 mol % R₂O.

According to a seventh aspect disclosed herein, a strengthened glass article includes the strengthened glass article according to any one of the previous aspects, wherein the glass composition is free of alkali ions.

According to an eighth aspect disclosed herein, a strengthened glass article includes the strengthened glass article according to any one of the previous aspects, wherein the glass composition comprises less than 5 mol % MgO and CaO.

According to a ninth aspect disclosed herein, a strengthened glass article includes the strengthened glass article according to any one of the previous aspects, wherein the glass composition comprises less than 10 mol % SrO and BaO.

According to a tenth aspect disclosed herein, a strengthened glass article includes the strengthened glass article according to any one of the previous aspects, wherein the glass article is strengthened by thermal tempering or mechanical strengthening.

According to an eleventh aspect disclosed herein, an electronic device comprises the strengthened glass article according to any one of the previous aspects.

According to a twelfth aspect disclosed herein, an electronic device comprises the electronic device according to the eleventh aspect, wherein the strengthened glass article is positioned directly adjacent to at least one wave layer having a dielectric constant that is less than the dielectric constant of the strengthened glass article.

According to a thirteenth aspect disclosed herein, a consumer electronic product comprises: a housing comprising a front surface, a back surface, and side surfaces; electrical components at least partially within the housing, the electrical components comprising a controller, a memory, and a display, the display at or adjacent the front surface of the housing; and a cover substrate disposed over the display, wherein at least one of a portion of the housing or the cover substrate comprises the strengthened glass article of any one of the preceding aspects.

According to a fourteenth aspect disclosed herein, a consumer electronic product includes the consumer electronic product according to the thirteenths aspect, wherein a portion of the housing comprises the strengthened glass article, and wherein the strengthened glass article comprises a region with a smaller thickness d₁ that is less than or equal to about 20% of a thickness of a remainder of the strengthened glass article d.

According to a fifteenth aspect disclosed herein, a method of forming a strengthened glass article comprises forming a glass article from a glass composition comprising less than 1.0 mol % R₂O, where R is an alkali ion, and strengthening the glass article using a thermal tempering or mechanical strengthening process, thereby forming the strengthened glass article, wherein the strengthened glass article has a dielectric constant of less than 6.25 and a dielectric loss tangent of less than 0.01 at 30 GHz.

According to a sixteenth aspect, a method comprises the method of the fifteenth aspect, wherein the strengthened glass article has a thermal conductivity of from 1.0 to 1.5 W/m*K at 25° C.

According to a seventeenth aspect, a method comprises the method of the fifteenth aspect or the sixteenth aspect, wherein the strengthened glass article has a dielectric constant of from 2 to 6 at 30 GHz.

According to an eighteenth aspect, a method comprises the method of any one of the fifteenth through seventeenth aspects, wherein the strengthened glass article has a dielectric loss tangent of from 0.0001 to 0.01 at 30 GHz.

According to a nineteenth aspect, a method comprises the method of any one of the fifteenth through eighteenth aspects, wherein the glass composition is selected from the group consisting of a silicate glass composition, a borate glass composition, a phosphate glass composition, an aluminate glass composition, a germanate glass composition, and combinations thereof.

According to a twentieth aspect, a method comprises the method of any one of the fifteenth through nineteenth aspects, wherein the glass composition is free of alkali ions.

According to a twenty-first aspect, a method comprises the method of any one of the fifteenth through twentieth aspects, wherein the glass composition comprises less than 5 mol % MgO and CaO.

According to a twenty-second aspect, a method comprises the method of any one of the fifteenth through twenty-first aspects, wherein the glass composition comprises less than 10 mol % SrO and BaO.

According to a twenty-third aspect, a method comprises the method of any one of the fifteenth through twenty-second aspects, wherein the strengthened glass article is positioned directly adjacent to and in contact with at least one wave layer having a dielectric constant less than the dielectric constant of the strengthened glass article.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a cross-sectional view of a thermally strengthened glass article according to one or more embodiments shown and described herein;

FIG. 2A is a cross-sectional view of a laminated glass article according to one or more embodiments shown and described herein;

FIG. 2B is a schematic view of an example fusion draw apparatus for making the laminated glass article according to one or more embodiments shown and described herein;

FIG. 3 is a cross-sectional view of a glass-polymer laminate according to one or more embodiments shown and described herein;

FIG. 4 is an exploded perspective view of a device including a strengthened glass article according to one or more embodiments shown and described herein;

FIG. 5 is a plot showing the coefficient of thermal expansion (CTE) (in ppm/° C.; Y-axis) as a function of temperature (T) (in ° C.; X-axis) for Sample Glass 3 and Corning® Eagle® XG (“EXG”) glass;

FIG. 6 is a plot showing the CTE (in ppm/° C.; Y-axis) as a function of temperature (T) (in ° C.; X-axis) for Sample Glass 4 and EXG glass;

FIG. 7 is a plot showing the stress relaxation (f(T); Y-axis) as a function of temperature (in ° C.; X-axis) for a glass laminate including Sample Glass 3 as the core and EXG glass as the clad according to one or more embodiments shown and described herein;

FIG. 8 is a plot showing the central tension (CT; in MPa; Y-axis) as a function of temperature (in ° C.; X-axis) for the glass laminate including Sample Glass 3 as the core and EXG glass as the clad according to one or more embodiments shown and described herein;

FIG. 9 is a plot showing the CTE (in ppm/° C.; Y-axis) as a function of temperature (T) (in ° C.; X-axis) for Sample Glass 4 and Sample Glass 1;

FIG. 10 is a plot showing the CTE (in ppm/° C.; Y-axis) as a function of temperature (T) (in ° C.; X-axis) for Sample Glass 5 and Sample Glass 2;

FIG. 11 is a cross-sectional view of a glass article according to one or more embodiments shown and described herein;

FIG. 12 is a plot of the transmission (dashed lines) and reflection (solid lines) for a substrate having a dielectric constant 2.7 over a frequency range from 0 to 55 GHz;

FIG. 13 is a plot of the transmission (dashed lines) and reflection (solid lines) for a substrate having a dielectric constant 7.0 over a frequency range from 0 to 55 GHz;

FIG. 14 is a plot of the transmission (dashed lines) and reflection (solid lines) as a function of the relative dielectric constant (X-axis) were analyzed for substrates of thicknesses from 200 μm to 1000 μm at a frequency of 28 GHz;

FIG. 15 is a plot of the transmission (dashed lines) and reflection (solid lines) as a function of the relative dielectric constant (X-axis) were analyzed for substrates of thicknesses from 200 μm to 1000 μm at a frequency of 38 GHz;

FIG. 16 is a cross-sectional view of a stack having a quarter wavelength transformer on both sides of the glass substrate according to one or more embodiments shown and described herein;

FIG. 17 is a plot of the transmission (dashed lines) and reflection (solid lines) for a stack as shown in FIG. 16, where the quarter wavelength transformer has a dielectric constant of 2.7 and a thickness of 1.6 mm, over a frequency range from 0 to 55 GHz;

FIG. 18 is a plot of the transmission (dashed lines) and reflection (solid lines) for a stack as shown in FIG. 16, where the quarter wavelength transformer has a dielectric constant of 3.5 and a thickness of 1.4 mm, over a frequency range from 0 to 55 GHz;

FIG. 19 is a cross-sectional view of a stack having a matching layer on one of the glass substrate according to one or more embodiments shown and described herein;

FIG. 20 is a plot of the transmission (dashed lines) and reflection (solid lines) for a stack as shown in FIG. 19, where the matching layer has a dielectric constant of 2.7 and a thickness of 1.83 mm, over a frequency range from 0 to 55 GHz;

FIG. 21 is a plot of the transmission (dashed lines) and reflection (solid lines) for a stack as shown in FIG. 19, where the matching layer has a dielectric constant of 7.0 and a thickness of 1.32 mm, over a frequency range from 0 to 55 GHz;

FIG. 22 is a cross-sectional view of a glass substrate having a pocket formed on one of the glass substrate according to one or more embodiments shown and described herein;

FIG. 23 is a plot of the transmission (dashed lines) and reflection (solid lines) as a function of the relative dielectric constant (X-axis) were analyzed for a substrate as shown in FIG. 22 for variable thicknesses from 200 μm to 1000 μm at a frequency of 28 GHz;

FIG. 24 is a plot of the transmission (dashed lines) and reflection (solid lines) as a function of the relative dielectric constant (X-axis) were analyzed for a substrate as shown in FIG. 22 for variable thicknesses from 200 μm to 1000 μm at a frequency of 38 GHz;

FIG. 25 is a cross-sectional view of a glass substrate having a pocket formed on one of the glass substrate and filled with a material having a low dielectric constant according to one or more embodiments shown and described herein;

FIG. 26 is a plot of the transmission (dashed lines) and reflection (solid lines) as a function of the relative dielectric constant (X-axis) were analyzed for a substrate as shown in FIG. 25 for variable thicknesses from 200 μm to 1000 μm at a frequency of 28 GHz; and

FIG. 27 is a plot of the transmission (dashed lines) and reflection (solid lines) as a function of the relative dielectric constant (X-axis) were analyzed for a substrate as shown in FIG. 25 for variable thicknesses from 200 μm to 1000 μm at a frequency of 38 GHz.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

As used herein, the singular forms “a,” “an” and “the” include plural referents unless the context clearly dictates otherwise. Thus, for example, reference to “a” component includes aspects having two or more such components, unless the context clearly indicates otherwise.

The term “coefficient of thermal expansion” or CTE is an average CTE over a particular range of temperatures. In various embodiments, the low temperature coefficient of thermal expansion (LTCTE) of the glass composition is averaged over a temperature range from about 20° C. to about 300° C. for a glass material or layer and from about 0° C. to about 40° C. for a polymer material or layer. In various embodiments, the high temperature coefficient of thermal expansion (HTCTE) of the glass composition refers to the CTE of the glass composition at the minimum temperature at which the glass has a viscosity of 10¹¹ Poise (the T₁₁ temperature). Because the T₁₁ temperature varies depending on the particular composition, when a difference in high temperature coefficient of thermal expansion (ΔHTCTE) is referenced, it refers to a difference in the CTE of the glass compositions at the lower T₁₁ of the pair of glass compositions.

Consumer devices, such as cell phones, are moving toward operation on a 5G network, which has a frequency range of operation at two bands: one at around 28 GHz and one at around 38 GHz. Conventional glass articles used as cover glass or in the back of the device can degrade the signal as a result of the thickness of the glass and the high dielectric constant of the glass. Reducing the dielectric constant can be achieved, for example, by reducing the alkali content in the glass. However, reducing or even eliminating the alkali ions from the glass composition prevents the glass from being strengthened through ion-exchange.

Accordingly, various embodiments described herein include strengthened glass articles formed from a glass composition comprising less than 1.0 mol % R₂O, where R is an alkali ion. The strengthened glass articles have a dielectric constant of less than 6.25 and a dielectric loss tangent of less than 0.01 at 30 GHz. Moreover, various embodiments described herein include glass articles that exhibit greater than 70% transmission at 28 GHz and at 38 GHz. Such glass articles can be strengthened by thermal tempering or mechanical strengthening processes, and may be particularly well-suited for use in consumer electronic products for use in 20 GHz-100 GHz communication bands, as will be described in greater detail below.

### Glass Compositions

In various embodiments, a strengthened glass article is formed from a glass composition comprising less than 1.0 mol % R₂O, where R is an alkali ion (i.e., lithium, sodium, potassium, rubidium, cesium, and francium). In embodiments, the glass composition may comprise less than 0.1 mol %, or may be free of alkali ions. For example, the glass composition can include from 0 mol % to 1.0 mol %, from 0 mol % to 0.75 mol %, from 0 mol % to 0.5 mol %, from 0 mol % to 0.25 mol %, from 0 mol % to 0.1 mol %, from 0 mol % to 0.05 mol %, or from 0 mol % to 0.01 mol %. Without being bound by theory, it is believed that the presence of alkali ions will lead to significant dielectric losses, particularly in the high frequency regime (e.g., in the microwave through IR range) where ions are relatively easily polarizable. Accordingly, in various embodiments, the presence of alkali ions in the glass composition, and in the final strengthened glass article is limited to less than 1.0 mol %, less than 0.1 mol %, or even less.

The glass composition of various embodiments is selected from the group consisting of a silicate glass composition, a borate glass composition, a phosphate glass composition, an aluminate glass composition, a germanate glass composition, and combinations thereof. However, it should be understood that other glass and/or glass ceramic compositions for forming the glass substrate are contemplated and possible.

The glass composition may generally include a combination of SiO₂, Al₂O₃, at least one alkaline earth oxides such as BeO, MgO, CaO, SrO and BaO, and/or alkali oxides, such as Li₂O, Na₂O, K₂O, Rb₂O and Cs₂O. In embodiments, the glass composition is alkali-free, while in other embodiments, the glass composition includes less than 1 mol % of one or more alkali oxides. In embodiments, the glass compositions may further include minor amounts of one or more additional oxides, such as, by way of example and not limitation, SnO₂, Sb₂O₃, ZrO₂, ZnO, or the like. These components may be added as fining agents.

In embodiments, the glass composition generally includes SiO₂ in an amount greater than or equal to 40 mol % and less than or equal to 80 mol %. When the content of SiO₂ is too small, the glass may have poor chemical and mechanical durability. On the other hand, when the content of SiO₂ is too large, melting ability of the glass decreases and the viscosity increases, so forming of the glass becomes difficult. In embodiments, SiO₂ is present in the glass composition in an amount greater than or equal to 50 mol % and less than or equal to 80 mol %, greater than or equal to 60 mol % and less than or equal to 80 mol %, or greater than or equal to 40 mol % and less than or equal to 60 mol %.

In embodiments, the glass composition comprises SiO₂ in an amount from greater than or equal to 0 mol % to less than or equal to 10 mol % and all ranges and sub-ranges between the foregoing values. In some embodiments, the glass composition comprises SiO₂ in amounts greater than or equal to 0.5 mol %, greater than or equal to 1 mol %, greater than or equal to 2 mol %, greater than or equal to 4 mol %, greater than or equal to 6 mol %, or greater than or equal to 8 mol %. In some embodiments, the glass composition comprises SiO₂ in amounts less than or equal to 8 mol %, less than or equal to 6 mol %, less than or equal to 4 mol %, less than or equal to 3 mol %, less than or equal to 2 mol %, less than or equal to 1 mol %, or less than or equal to 0.5 mol %. It should be understood that, in some embodiments, any of the above ranges may be combined with any other range. However, in other embodiments, the glass composition comprises SiO₂ in an amount from greater than or equal to 0.5 mol % to less than or equal to 8 mol %, from greater than or equal to 1 mol % to less than or equal to 6 mol %, or from greater than or equal to 2 mol % to less than or equal to 4 mol % and all ranges and sub-ranges between the foregoing values.

However, in various embodiments, the glass composition may be a high-silica content glass composition comprising greater than or equal to 70 mol % SiO₂. For example, the glass composition may include greater than or equal to 70 mol % SiO₂, greater than or equal to 75 mol % SiO₂, greater than or equal to 80 mol % SiO₂, greater than or equal to 85 mol % SiO₂, greater than or equal to 90 mol % SiO₂, greater than or equal to 95 mol % SiO₂, or even greater than or equal to 99 mol % SiO₂. In some particular embodiments, the glass is high purity fused silica (HPFS).

The glass composition may also include Al₂O₃. Increased amounts of Al₂O₃ may increase the softening point of the glass, thereby reducing the formability of the glass. The glass compositions described herein may include Al₂O₃ in an amount greater than or equal to 10 mol % and less than or equal to 30 mol % greater than or equal to 10 mol % and less than or equal to 25 mol %, greater than or equal to 10 mol % and less than or equal to 20 mol %, greater than or equal to 10 mol % and less than or equal to 15 mol %, greater than or equal to 15 mol % and less than or equal to 30 mol %, greater than or equal to 15 mol % and less than or equal to 25 mol %, greater than or equal to 15 mol % and less than or equal to 20 mol %, greater than or equal to 20 mol % and less than or equal to 30 mol %, greater than or equal to 20 mol % and less than or equal to 25 mol %, or greater than or equal to 25 mol % and less than or equal to 30 mol %. However, in some embodiments, the glass composition is free of Al₂O₃.

In embodiments described herein, the boron concentration in the glass composition is a flux which may be added to the glass composition to make the viscosity-temperature curve less steep. The boron concentration also lowers the entire curve, thereby improving the formability of the glass and softening the glass. Accordingly, B₂O₃ may be added to the glass composition to improve mechanical damage resistance, increase fracture toughness, and increase the HTCTE. In embodiments, the glass composition includes greater than or equal to 0 mol % B₂O₃ and less than or equal to 10 mol % B₂O₃, greater than or equal to 0 mol % and less than or equal to 7.5 mol % B₂O₃, greater than or equal to 0 mol % and less than or equal to 5 mol % B₂O₃, greater than or equal to 0 mol % and less than or equal to 2.5 mol % B₂O₃, greater than or equal to 2.5 mol % B₂O₃ and less than or equal to 10 mol % B₂O₃, greater than or equal to 2.5 mol % and less than or equal to 7.5 mol % B₂O₃, greater than or equal to 2.5 mol % and less than or equal to 5 mol % B₂O₃, greater than or equal to 5 mol % B₂O₃ and less than or equal to 10 mol % B₂O₃, greater than or equal to 5 mol % and less than or equal to 7.5 mol % B₂O₃, or greater than or equal to 7.5 mol % and less than or equal to 10 mol % B₂O₃. In embodiments, the glass composition may be free from boron and compounds containing boron.

In embodiments, such as embodiments in which the glass composition is a borate glass composition, the glass composition may include from 25 mol % to 70 mol % B₂O₃. In some embodiments, the glass composition comprises B₂O₃ in amounts greater than or equal to 30 mol %, greater than or equal to 35 mol %, greater than or equal to 40 mol %, greater than or equal to 45 mol %, greater than or equal to 50 mol %, greater than or equal to 55 mol %, greater than or equal to 60 mol %, or greater than or equal to 65 mol %. In some embodiments, the glass composition comprises B₂O₃ in amounts less than or equal to 65 mol %, less than or equal to 60 mol %, less than or equal to 55 mol %, less than or equal to 50 mol %, less than or equal to 45 mol %, less than or equal to 40 mol %, less than or equal to 35 mol %, or less than or equal to 30 mol %. It should be understood that, in some embodiments, any of the above ranges may be combined with any other range. However, in other embodiments, the glass composition comprises B₂O₃ in an amount from greater than or equal to 30 mol % to less than or equal to 65 mol %, from greater than or equal to 35 mol % to less than or equal to 60 mol %, from greater than or equal to 40 mol % to less than or equal to 55 mol %, or from greater than or equal to 45 mol % to less than or equal to 50 mol % and all ranges and sub-ranges between the foregoing values.

In embodiments, the sum of the glass network formers B₂O₃+Al₂O₃+SiO₂ is from greater than or equal to 35 mol % to less than or equal to 100 mol % and all ranges and sub-ranges between the foregoing values. In some embodiments, the glass composition comprises a sum of the glass network formers B₂O₃+Al₂O₃+SiO₂ that is greater than or equal to 36 mol %, such as greater than or equal to 38 mol %, greater than or equal to 40 mol %, greater than or equal to 42 mol %, greater than or equal to 44 mol %, greater than or equal to 46 mol %, greater than or equal to 48 mol %, greater than or equal to 50 mol %, greater than or equal to 52 mol %, greater than or equal to 54 mol %, greater than or equal to 56 mol %, greater than or equal to 58 mol %, greater than or equal to 60 mol %, greater than or equal to 62 mol %, greater than or equal to 64 mol %, greater than or equal to 66 mol %, greater than or equal to 68 mol %, greater than or equal to 70 mol %, greater than or equal to 72 mol %, or greater than or equal to 74 mol %. In some embodiments, the sum of the glass network formers B₂O₃+Al₂O₃+SiO₂ is less than or equal to 100 mol %, such as less than or equal to 99 mol %, less than or equal to 95 mol %, less than or equal to 90 mol %, less than or equal to 85 mol %, less than or equal to 80 mol %, less than or equal to 75 mol %, less than or equal to 72 mol %, less than or equal to 70 mol %, less than or equal to 68 mol %, less than or equal to 66 mol %, less than or equal to 64 mol %, less than or equal to 62 mol %, less than or equal to 60 mol %, less than or equal to 58 mol %, less than or equal to 56 mol %, less than or equal to 54 mol %, less than or equal to 52 mol %, less than or equal to 50 mol %, less than or equal to 48 mol %, less than or equal to 46 mol %, less than or equal to 44 mol %, less than or equal to 42 mol %, less than or equal to 40 mol %, less than or equal to 38 mol %, or less than or equal to 36 mol %. It should be understood that, in some embodiments, any of the above ranges may be combined with any other range. However, in other embodiments, the glass composition comprises a sum of the glass network formers B₂O₃+Al₂O₃+SiO₂ in an amount from greater than or equal to 36 mol % to less than or equal to 100 mol %, from greater than or equal to 40 mol % to less than or equal to 70 mol %, from greater than or equal to 45 mol % to less than or equal to 65 mol %, or from greater than or equal to 50 mol % to less than or equal to 60 mol % and all ranges and sub-ranges between the foregoing values.

In embodiments in which the glass composition is a phosphate glass composition, P₂O₅ is the primary glass former in the glass composition. Its tendency to form linear molecular structures, in contrast to the 3-D networks typical in silicate glasses, offers an explanation for the low melting and transition temperatures of such glass compositions. The level of P₂O₅ affects water durability of the glass. Where P₂O₅ content is higher than 34 mol %, the glass will have a less than satisfactory water durability. However on the other hand, where the P₂O₅ level is below 31 mol %, the glass divitrifies too easily to be suitable for compounding with polymers intimately at the working temperature. Although in embodiments the P₂O₅ level in the glass composition is from 32.5 mol % to 34 mol %, it is contemplated that still other amounts of P₂O₅ are contemplated, depending on the particular embodiment.

Embodiments of the glass compositions may further include less than 1.0 mol % of one or more alkali oxides (e.g., Na₂O, K₂O, Li₂O, or the like). The alkali oxides may increase the dielectric constant and dielectric loss tangent of the glass article. The alkali oxides are generally present in the glass composition in an amount greater than or equal to 0 mol % and less than or equal to 1.0 mol %. As set forth above, in embodiments, the amount of alkali oxides may be from 0 mol % to 1.0 mol %, from 0 mol % to 0.75 mol %, from 0 mol % to 0.5 mol %, from 0 mol % to 0.25 mol %, from 0 mol % to 0.1 mol %, from 0 mol % to 0.05 mol %, or from 0 mol % to 0.01 mol %. In various embodiments described herein, the glass article is strengthened by a method other than chemical strengthening (i.e., ion exchange). Accordingly, in embodiments, one or more of the glass compositions are free of alkali oxides.

As provided hereinabove, embodiments of the glass compositions may further include one or more alkaline earth oxides. The alkaline earth oxide may include, for example, MgO, CaO, SrO, BaO, or combinations thereof.

Alkaline earth oxides improve the meltability of the glass batch oxides and increase the chemical durability of the glass composition. In the glass compositions described herein, the glass compositions generally include at least one alkaline earth oxide in an amount greater than or equal to 0 mol % and less than or equal to 15 mol %, greater than or equal to 0 mol % and less than or equal to 12 mol %, greater than or equal to 0 mol % and less than or equal to 5 mol %, greater than or equal to 0 mol % and less than or equal to 2.5 mol %, greater than or equal to 2.5 mol % and less than or equal to 15 mol %, greater than or equal to 2.5 mol % and less than or equal to 12 mol %, greater than or equal to 2.5 mol % and less than or equal to 5 mol %, greater than or equal to 5 mol % and less than or equal to 15 mol %, greater than or equal to 5 mol % and less than or equal to 12 mol %, or greater than or equal to 12 mol % and less than or equal to 15 mol %. In some embodiments, the glass composition is free of alkaline earth oxides.

MgO may be present in an amount from greater than or equal to 0 mol % and less than or equal to 15 mol %, greater than or equal to 0 mol % and less than or equal to 12 mol %, greater than or equal to 0 mol % and less than or equal to 5 mol %, greater than or equal to 0 mol % and less than or equal to 2.5 mol %, greater than or equal to 2.5 mol % and less than or equal to 15 mol %, greater than or equal to 2.5 mol % and less than or equal to 12 mol %, greater than or equal to 2.5 mol % and less than or equal to 5 mol %, greater than or equal to 5 mol % and less than or equal to 15 mol %, greater than or equal to 5 mol % and less than or equal to 12 mol %, or greater than or equal to 12 mol % and less than or equal to 15 mol %. However, it is contemplated that in embodiments, MgO may not be included in the glass composition.

As another example, CaO may be present in the glass composition in an amount of from 0 mol % and less than or equal to 15 mol %, greater than or equal to 0 mol % and less than or equal to 12 mol %, greater than or equal to 0 mol % and less than or equal to 5 mol %, greater than or equal to 0 mol % and less than or equal to 2.5 mol %, greater than or equal to 2.5 mol % and less than or equal to 15 mol %, greater than or equal to 2.5 mol % and less than or equal to 12 mol %, greater than or equal to 2.5 mol % and less than or equal to 5 mol %, greater than or equal to 5 mol % and less than or equal to 15 mol %, greater than or equal to 5 mol % and less than or equal to 12 mol %, or greater than or equal to 12 mol % and less than or equal to 15 mol %. In embodiments, CaO may be not be present in the glass composition.

In various embodiments, the glass composition includes less than 5 mol % total moles of MgO and CaO. For example, the glass composition may include from 0 mol % to 5 mol % total moles of MgO and CaO, from 0 mol % to 4 mol % total moles of MgO and CaO, from 0 mol % to 3 mol % total moles of MgO and CaO, from 0 mol % to 2 mol % total moles of MgO and CaO, from 0 mol % to 1 mol % total moles of MgO and CaO, from 0 mol % to 0.5 mol % total moles of MgO and CaO, from 0.5 mol % to 5 mol % total moles of MgO and CaO, from 0.5 mol % to 4 mol % total moles of MgO and CaO, from 0.5 mol % to 3 mol % total moles of MgO and CaO, from 0.5 mol % to 2 mol % total moles of MgO and CaO, from 0.5 mol % to 1 mol % total moles of MgO and CaO, from 1 mol % to 5 mol % total moles of MgO and CaO, from 1 mol % to 4 mol % total moles of MgO and CaO, from 1 mol % to 3 mol % total moles of MgO and CaO, from 1 mol % to 2 mol % total moles of MgO and CaO, from 2 mol % to 5 mol % total moles of MgO and CaO, from 2 mol % to 4 mol % total moles of MgO and CaO, from 2 mol % to 3 mol % total moles of MgO and CaO, from 3 mol % to 5 mol % total moles of MgO and CaO, from 3 mol % to 4 mol % total moles of MgO and CaO, or from 4 mol % to 5 mol % total moles of MgO and CaO. In embodiments, the glass composition may be free from MgO and CaO.

In embodiments, SrO may be included in the glass composition in an amount greater than or equal to 0 mol % and less than or equal to 10 mol %, greater than or equal to 0 mol % and less than or equal to 7.5 mol %, greater than or equal to 0 mol % and less than or equal to 5 mol %, greater than or equal to 0 mol % and less than or equal to 2.5 mol %, amount greater than or equal to 2.5 mol % and less than or equal to 10 mol %, greater than or equal to 2.5 mol % and less than or equal to 7.5 mol %, greater than or equal to 2.5 mol % and less than or equal to 5 mol %, greater than or equal to 5 mol % and less than or equal to 10 mol %, greater than or equal to 5 mol % and less than or equal to 7.5 mol %, or greater than or equal to 7.5 mol % and less than or equal to 10 mol %. In embodiments, SrO may not be present in the glass composition.

In embodiments including BaO, the BaO may be present in an amount greater than or equal to 0 mol % and less than or equal to 10 mol %, greater than or equal to 0 mol % and less than or equal to 7.5 mol %, greater than or equal to 0 mol % and less than or equal to 5 mol %, greater than or equal to 0 mol % and less than or equal to 2.5 mol %, amount greater than or equal to 2.5 mol % and less than or equal to 10 mol %, greater than or equal to 2.5 mol % and less than or equal to 7.5 mol %, greater than or equal to 2.5 mol % and less than or equal to 5 mol %, greater than or equal to 5 mol % and less than or equal to 10 mol %, greater than or equal to 5 mol % and less than or equal to 7.5 mol %, or greater than or equal to 7.5 mol % and less than or equal to 10 mol %. In embodiments, BaO may be present in the glass composition in an amount less than or equal to about 2 wt % or even less than or equal to about 1 wt %. In embodiments, BaO may not be present in the glass composition.

In various embodiments, the glass composition includes less than 10 mol % total moles of SrO and BaO. For example, the glass composition may include from 0 mol % to 10 mol % total moles of SrO and BaO, from 0 mol % to 7.5 mol % total moles of SrO and BaO, from 0 mol % to 5 mol % total moles of SrO and BaO, from 0 mol % to 2.5 mol % total moles of SrO and BaO, from 0 mol % to 1.0 mol % total moles of SrO and BaO, from 0 mol % to 0.5 mol % total moles of SrO and BaO, from 0.5 mol % to 10 mol % total moles of SrO and BaO, from 0.5 mol % to 7.5 mol % total moles of SrO and BaO, from 0.5 mol % to 5 mol % total moles of SrO and BaO, from 0.5 mol % to 2.5 mol % total moles of SrO and BaO, from 0.5 mol % to 1.0 mol % total moles of SrO and BaO, from 1.0 mol % to 10 mol % total moles of SrO and BaO, from 1.0 mol % to 7.5 mol % total moles of SrO and BaO, from 1.0 mol % to 5 mol % total moles of SrO and BaO, from 1.0 mol % to 2.5 mol % total moles of SrO and BaO, from 2.5 mol % to 10 mol % total moles of SrO and BaO, from 2.5 mol % to 7.5 mol % total moles of SrO and BaO, from 2.5 mol % to 5 mol % total moles of SrO and BaO, from 5 mol % to 10 mol % total moles of SrO and BaO, from 5 mol % to 7.5 mol % total moles of SrO and BaO, or from 7.5 mol % to 10 mol % total moles of SrO and BaO. In embodiments, the glass composition may be free from SrO and BaO.

In addition to the SiO₂, Al₂O₃, alkali oxides and alkaline earth oxides, embodiments of glass compositions may optionally include one or more fining agents, such as, by way of example and not limitation, SnO₂, Sb₂O₃, As₂O₃, and/or halogens such as F⁻, and/or Cl⁻ (from NaCl or the like). When a fining agent is present in the glass composition, the fining agent may be present in amount less than or equal to 2 mol % or even less than or equal to 0.1 mol %. When the content of the fining agent is too large, the fining agent may enter the glass structure and affect various glass properties. However, when the content of the fining agent is too low, the glass may be difficult to form. For example, in embodiments, SnO₂ is included as a fining agent in an amount greater than or equal to 0.1 mol % to less than or equal to 2 mol %.

Other metal oxides may additionally be included in the glass compositions. For example, the glass composition may further include ZnO or ZrO₂, each of which improves the resistance of the glass composition to chemical attack. In such embodiments, the additional metal oxide may be present in an amount which is greater than or equal to 0 mol % and less than or equal to 5 mol %. If the content of ZrO₂ is too high, it may not dissolve in the glass composition, may result in defects in the glass composition, and may drive the Young's modulus up. In embodiments, ZnO may be included in an amount of less than or equal to 5 mol %, or less than or equal to 2.5 mol %. In embodiments, ZnO may be included as a substitute for one or more of the alkaline earth oxides, such as a partial substitute for MgO or in addition to or in place of at least one of CaO, BaO, or SrO. Accordingly, the content of ZnO in the glass composition can have the same effects as described above with respect to alkaline earth oxides if it is too high or too low.

In embodiments, TiO₂ may be included in the glass compositions. For example, the TiO₂ may be present in an amount which is greater than or equal to 0 mol % and less than or equal to 5 mol % to increase the HTCTE of the glass. In embodiments, TiO₂ may be included in an amount of greater than 0 mol %, greater than or equal to 0.5 mol %, greater than or equal to 1 mol %, greater than or equal to 1.5 mol %, or greater than or equal to 2 mol %. TiO₂ may be included in an amount of less than or equal to 5 mol %, less than or equal to 4.5 mol %, less than or equal to 4 mol %, less than or equal to 3.5 mol %, or less than or equal to 3 mol %. In embodiments, the glass composition may be free of (e.g., contain zero) TiO₂.

Various glass compositions are contemplated. For example, the glass composition may be a silicate, borate, aluminate, germanate or combination thereof (e.g., borosilicate, aluminosilicate, or phosphosilicate) glass composition containing less than 1 mol % R₂O, where R is an alkali ion. As another example, the glass composition may be a silicate, borate, aluminate, germanate or combination thereof (e.g., borosilicate, aluminosilicate, or phosphosilicate) glass composition containing less than 0.1 mol % R₂O, where R is an alkali ion. As yet another example, the glass composition may be a silicate, borate, aluminate, germanate or combination thereof (e.g., borosilicate, aluminosilicate, or phosphosilicate) glass composition containing less than 0.1 mol % R₂O, where R is an alkali ion, and less than 5 mol % total moles of MgO and CaO. As another example, the glass composition may be a silicate, borate, aluminate, germanate or combination thereof (e.g., borosilicate, aluminosilicate, or phosphosilicate) glass composition containing less than 0.1 mol % R₂O, where R is an alkali ion, and less than 10 mol % total moles of SrO and BaO. In another example, the glass composition may be a silicate, borate, aluminate, germanate or combination thereof (e.g., borosilicate, aluminosilicate, or phosphosilicate) glass composition containing less than 0.1 mol % R₂O, where R is an alkali ion, less than 5 mol % total moles of MgO and CaO, and less than 10 mol % total moles of SrO and BaO. In embodiments, suitable commercially available glass articles include glass articles sold as Corning® Eagle® XG, Corning® Eagle® 2000, Corning® 7059, Corning Code 1737, LOTUS™ NXT, all available from Corning Incorporated (Corning, N.Y.), AN WIZUS™ and AN100™ available from AGC Inc., OA11 and OA12 available from Nippon Electric Glass Co., and HBDX. It should be understood that other glass, glass ceramic, ceramic, multi-layers, or composite compositions may also be utilized.

Although any one of a variety of glass compositions may be used, in various embodiments, the glass article has a dielectric constant of less than 6.25 at 30 GHz. The dielectric constant (k), also known as the relative permittivity, of a material is a number relating the ability of the material to carry alternating current compared to the ability of a vacuum to carry alternating current. In other words, the relative permittivity of a material is the factor by which the electric field between the charges is decreased relative to vacuum. The dielectric constant of a material can be measured with a test capacitor. The capacitance of the test capacitor with a vacuum between the plates is measured and the capacitance of the test capacitor with the material of interest between the plates is measured. The dielectric constant is the ratio of the capacitance with the test material over the capacitance with a vacuum. In embodiments, the glass article has a dielectric constant of less than 6.00, less than 5.75, less than 5.50, less than 5.25, less than 5.15, less than 5.00, less than 4.75, less than 4.50, less than 4.25, or even less than 4.00 at 30 GHz. For example, the glass article may have a dielectric constant at 30 GHz of from 2.00 to 6.00, from 2.25 to 5.75, from 2.50 to 5.50, from 2.75 to 5.15, from 3.00 to 5.00, from 4.00 to 5.00, from 4.50 to 5.00, from 4.50 to 4.90, from 3.25 to 4.75, from 3.50 to 4.50, from 3.75 to 4.25, and all ranges and sub-ranges between the foregoing values.

According to various embodiments, the glass article has a dielectric loss tangent of less than 0.01 at 30 GHz. In embodiments, the glass article has a dielectric loss tangent at 30 GHz of less than 0.01, less than 0.009, less than 0.008, less than 0.007, less than 0.006, less than 0.005, less than 0.004, less than 0.003, or less than 0.002. For example, the glass article may have a dielectric loss tangent at 30 GHz from 0.001 to 0.01, from 0.001 to 0.009, from 0.001 to 0.008, from 0.001 to 0.007, from 0.001 to 0.006, from 0.001 to 0.005, from 0.001 to 0.004, from 0.001 to 0.003, from 0.001 to 0.002, from 0.002 to 0.01, from 0.002 to 0.009, from 0.002 to 0.008, from 0.002 to 0.007, from 0.002 to 0.006, from 0.002 to 0.005, from 0.002 to 0.004, from 0.002 to 0.003, from 0.003 to 0.01, from 0.003 to 0.009, from 0.003 to 0.008, from 0.003 to 0.007, from 0.003 to 0.006, from 0.003 to 0.005, from 0.003 to 0.004, from 0.004 to 0.01, from 0.004 to 0.009, from 0.004 to 0.008, from 0.004 to 0.007, from 0.004 to 0.006, from 0.004 to 0.005, from 0.005 to 0.01, from 0.005 to 0.009, from 0.005 to 0.008, from 0.005 to 0.007, from 0.005 to 0.006, from 0.006 to 0.01, from 0.006 to 0.009, from 0.006 to 0.008, from 0.006 to 0.007, from 0.007 to 0.01, from 0.007 to 0.009, from 0.007 to 0.008, from 0.008 to 0.01, from 0.008 to 0.009, from 0.009 to 0.01, and all ranges and sub-ranges between the foregoing values.

Without being bound by theory, it is believed that dielectric loss mechanisms involving ion jump, vibration, or deformation processes increase exponentially with temperature. Accordingly, in various embodiments, the glass article has a thermal conductivity at 25° C. of from 1.0 to 1.5 W/m*K to enable the glass article to dissipate heat and mitigate the increasing dielectric losses. For example, the glass article may have a thermal conductivity at 25° C. of from 1.0 to 1.5 W/m*K, from 1.0 to 1.4 W/m*K, from 1.0 to 1.3 W/m*K, from 1.0 to 1.2 W/m*K, from 1.0 to 1.1 W/m*K, from 1.1 to 1.5 W/m*K, from 1.1 to 1.4 W/m*K, from 1.1 to 1.3 W/m*K, from 1.1 to 1.2 W/m*K, from 1.2 to 1.5 W/m*K, from 1.2 to 1.4 W/m*K, from 1.2 to 1.3 W/m*K, from 1.3 to 1.5 W/m*K, from 1.3 to 1.4 W/m*K, from 1.4 to 1.5 W/m*K, and all ranges and sub-ranges between the foregoing values.

### Strengthening Methods

In various embodiments, the glass article is a strengthened glass article. Strengthened glass articles can exhibit greater resistance to fracture than unstrengthened glass articles. Moreover, if a glass article possesses sufficient levels of strengthening, relative to its thickness, it may divide into small fragments upon breakage instead of into large or elongated fragments with sharp edges. However, because the above-referenced glass compositions are have a low alkali content or are alkali-free, the glass articles of various embodiments are strengthened by means that do not involve ion exchange. Accordingly, in various embodiments, the glass article is strengthened by thermal tempering or by mechanical strengthening. For example, mechanical strengthening can include lamination of the glass article with a polymer layer to form a glass-polymer laminate or lamination of multiple glass layers, each layer having a different coefficient of thermal expansion (CTE). In various embodiments, the layers have a difference in high temperature coefficient of thermal expansion (HTCTE), or ΔHTCTE, measured at the lower T₁₁ (10¹¹ poise temperature) of the layers of glass. Various methods of strengthening the glass article will now be described.

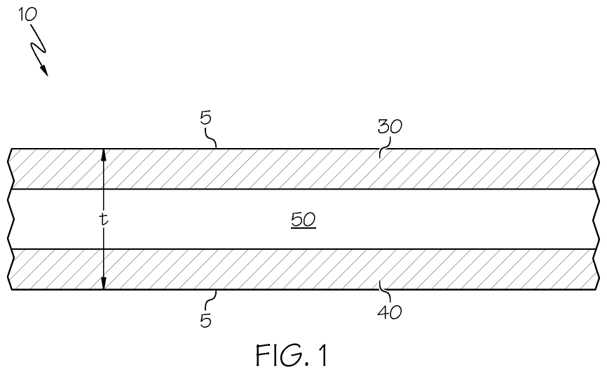

In thermal (or “physical”) strengthening of glass articles, a glass article is heated to an elevated temperature above the glass transition temperature of the glass and then the surfaces of the article are rapidly cooled (“quenched”) while the inner regions of the sheet cool at a slower rate. The inner regions cool more slowly because they are insulated by the thickness and the fairly low thermal conductivity of the glass. The differential cooling produces a residual compressive stress in the glass surface regions (e.g., regions 30, 40 shown in FIG. 1), balanced by a residual tensile stress in the central regions (e.g., region 50 shown in FIG. 1) of the glass article 10. As an approximation, the stress distribution in thermally tempered glass can be represented by a simple parabola, with the magnitude of the surface compressive stress approximately equal to twice the central tension (i.e., CS=2CT). Unlike ion-exchange strengthening, thermal tempering is applicable to all glass compositions, including those that are substantially free of alkali ions.

In embodiments, the glass article 10 may be thermally strengthened by heating the glass article 10 to a predetermined temperature in a radiant energy furnace, a convection furnace, or in a combined mode furnace using both techniques. The glass article 10 is then quenched, such as by using convection to blow large amounts of ambient air against or along the glass surface 5. This gas cooling process is predominately convective, whereby the heat transfer is by mass motion of the fluid, via diffusion and advection, as the gas carries the heat away from the hot glass article 10. Other methods of both heating and quenching the glass article 10 are contemplated, including any thermal tempering methods known and used in the art. For example, conductive cooling methods, including liquid contact and solid contact cooling, may be used to quench the glass article 10 after heating.

It should be understood that the particular temperature above which the glass article 10 is heated, as well as the cooling rate and cooling techniques employed, may vary depending on the particular embodiment. For example, the temperature above which the glass article 10 is heated may vary depending on the glass composition, and the cooling rate and technique may vary depending on the size of the glass article 10 (e.g., the thickness t).

Compressive stresses of in thermally tempered glass articles 10 herein can vary as a function of thickness t of the glasses. In various embodiments, glass articles 10 having a thickness of 3 mm or less have a compressive stress (e.g., surface compressive stress) of at least 80 MPa, at least 100 MPa, at least 150 MPa, at least 200 MPa, at least 250 MPa, at least 300 MPa, at least 350 MPa, at least 400 MPa, and/or no more than 1 GPa. In embodiments, glass articles 10 having a thickness of 2 mm or less have a compressive stress of at least 80 MPa, at least 100 MPa, at least 150 MPa, at least 175 MPa, at least 200 MPa, at least 250 MPa, at least 300 MPa, at least 350 MPa, at least 400 MPa, and/or no more than 1 GPa. In embodiments, glass articles 10 having a thickness of 1.5 mm or less have a compressive stress of at least 80 MPa, at least 100-MPa, at least 150 MPa, at least 175 MPa, at least 200 MPa, at least 250 MPa, at least 300-MPa, at least 350 MPa, and/or no more than 1 GPa. In embodiments, glass articles 10 having a thickness of 1 mm or less have a compressive stress of at least 80 MPa, at least 100 MPa, at least 150 MPa, at least 175 MPa, at least 200 MPa, at least 250 MPa, at least 300 MPa, and/or no more than 1 GPa. In embodiments, glass articles 10 having a thickness of 0.5 mm or less have a compressive stress of at least 50 MPa, at least 80 MPa, at least 100 MPa, at least 150 MPa, at least 175 MPa, at least 200 MPa, at least 250 MPa, and/or no more than 1 GPa.

In some embodiments, the thermally induced central tension (e.g., in region 50) in glass articles 10 formed by the processes and systems disclosed herein may be greater than 40 MPa, greater than 50 MPa, greater than 75 MPa, greater than 100 MPa. In embodiments, the thermally induced central tension may be less than 300 MPa, or less than 400 MPa. In embodiments, the thermally induced central tension may be from about 50 MPa to about 300 MPa, about 60 MPa to about 200 MPa, about 70 MPa to about 150 MPa, or about 80 MPa to about 140 MPa. In embodiments, the thermally strengthened glass articles 10 are particularly thin. Because very high-heat transfer rates can be applied, significant thermal effects, for example central tensions of at least 10 or even at least 20 MPa, can be produced in glass articles having a thickness of less than 0.3 mm.

In embodiments, the glass article 10 comprises a glass material, a ceramic material, a glass-ceramic material, or combinations thereof. For example, the glass article 10 may comprise any of the compositions described hereinabove. The glass article 10 may be formed using any suitable forming process, such as a downdraw process such as a fusion process. Forming the glass article 10 using a fusion process can enable the glass layer to have surfaces with superior flatness and smoothness compared to glass sheets produced by other methods. The fusion process is described in U.S. Pat. Nos. 3,338,696 and 3,682,609, each of which is hereby incorporated by reference in its entirety. Other suitable glass forming processes may include float processes, updraw processes, or slot draw processes.

In embodiments, the glass article may be strengthened through a lamination process. The lamination process may include, for example, laminating multiple glass layers with one another or with a polymer sheet.

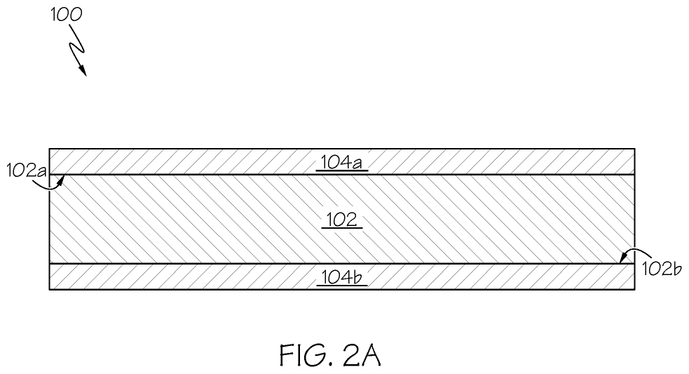

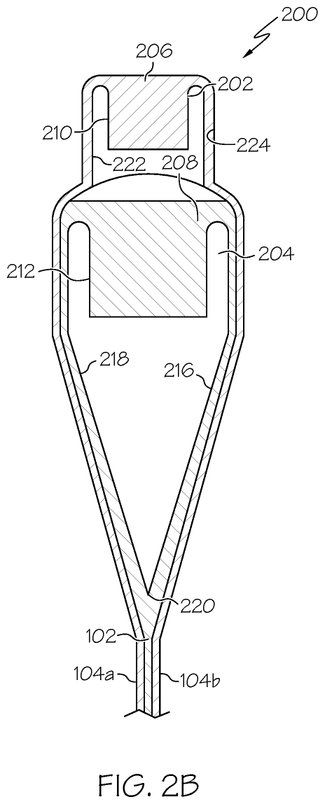

FIG. 2A schematically depicts a glass substrate 100 according to various embodiments. In particular, the glass article 100 includes a core layer 102 interposed between a first cladding layer 104a and a second cladding layer 104b. In various embodiment, each of the layers, including the core layer 102, the first cladding layer 104a, and the second cladding layer 104b, comprises, independently, a glass-based material including, but not limited to, a glass, a glass-ceramic, a ceramic, or a combination thereof. In embodiments, the glass-based material of the core layer 102 is different from the glass-based material of the first cladding layer 104a and the second cladding layer 104b. In embodiments, each of the layers, including the core layer 102, the first cladding layer 104a, and the second cladding layer 104b, has an alkali content of less than 1.0 mol %, as described hereinabove.

FIG. 2A illustrates the core layer 102 having a first surface 102a and a second surface 102b opposed to the first surface 102a. The first cladding layer 104a is fused directly to the first surface 102a of the core layer 102 and the second cladding layer 104b is fused directly to the second surface 102b of the core layer 102. The first and second cladding layers 104a, 104b may be fused to the core layer 102 without any additional materials, such as adhesives, polymer layers, coating layers, or the like being disposed between the glass-based layers. Thus, in this instance, the first surface 102a is directly adjacent the first cladding layer 104a and the second surface 102b is directly adjacent the second cladding layer 104b. In other embodiments, the layers 102, 104a, and 104b are coupled (e.g., adhered) together using adhesives or the like.

In various embodiments, the glass article 100 is configured so that at least one of the cladding layers 104a, 104b and the core layer 102 have different coefficients of thermal expansion (CTE). According to various embodiments described herein, at least one of the cladding layers 104a, 104b is formed from a glass clad composition and has an average clad coefficient of thermal expansion CTE_{clad} that is less than an average core coefficient of thermal expansion CTE_{core}.

It should be appreciated that in glass compositions that have low alkali content, or glass compositions that are free of alkali metals, it can be difficult to obtain a large difference in the coefficient of thermal expansions at low temperatures (e.g., from 23° C. up to about 300° C.). Accordingly, stress can be generated through a CTE mismatch at a higher temperature (e.g., the T₁₁ temperature of one of the glass compositions). In embodiments, the glass article 100 is configured so that at least one of the cladding layers 104a, 104b and the core layer 102 have a difference in high temperature coefficients of thermal expansion (ΔHTCTE). According to various embodiments described herein, at least one of the cladding layers 104a, 104b is formed from a glass clad composition and has a clad coefficient of thermal expansion CTE_{clad} that is less than a core coefficient of thermal expansion CTE_{core} at the lower temperature of the T₁₁ temperatures for the glass compositions.

In some embodiments, at least one of the glass compositions comprises a LTCTE of at least about 0.5×10⁻⁶/° C., at least about 1×10⁻⁶/° C., at least about 1.5×10⁻⁶/° C., at least about 2×10⁻⁶/° C., at least about 2.5×10⁻⁶/° C., or at least about 3×10⁻⁶/° C. Additionally, or alternatively, at least one of the glass compositions comprises a LTCTE of at most about 9×10⁻⁶/° C., at most about 8×10⁻⁶/° C., at most about 7×10⁻⁶/° C., at most about 6×10⁻⁶/° C., at most about 5×10⁻⁶/° C., or at most about 4×10⁻⁶/° C. For example, at least one of the glass compositions comprises a LTCTE of about 2.7×10⁻⁶/° C. to about 3.7×10⁻⁶/° C., including all ranges and sub-ranges within.

In some embodiments, at least one of the glass compositions comprises a HTCTE of at least about 11×10⁻⁶/° C., at least about 11.5×10⁻⁶/° C., at least about 12×10⁻⁶/° C., at least about 12.5×10⁻⁶/° C., at least about 13×10⁻⁶/° C., or at least about 13.5×10⁻⁶/° C. Additionally, or alternatively, at least one of the glass compositions comprises a HTCTE of at most about 25×10⁻⁶/° C., at most about 22.5×10⁻⁶/° C., at most about 21×10⁻⁶/° C., or at most about 20×10⁻⁶/° C. For example, at least one of the glass compositions comprises a HTCTE of about 12×10⁻⁶/° C. to about 22×10⁻⁶/° C., including all ranges and sub-ranges within.

In such embodiments, a nearly uniform compressive stress forms across the thickness of the cladding layers 104a, 104b, with a balancing tensile stress within the core layer 102. Such glass laminates are mechanically strengthened, and can endure damages, such as damages that may occur during handling, better than non-strengthened glass articles.

In various embodiments, the first and second cladding layers 104a, 104b each have a compressive stress of greater than 50 MPa or greater than 80 MPa. For example, each of the cladding layers 104a, 104b may have a compressive stress of greater than 50 MPa, greater than 60 MPa, greater than 65 MPa, greater than 70 MPa, greater than 75 MPa, greater than 80 MPa, greater than 85 MPa, greater than 90 MPa, or greater than 95 MPa. In embodiments, each of the cladding layers 104a, 104b may have a compressive stress of less than 120 MPa, less than 115 MPa, less than 110 MPa, less than 105 MPa, less than 100 MPa, or less than 95 MPa. Each of the cladding layers can have a compressive stress of from 50 MPa to 120 MPa, from 50 MPa to 115 MPa, from 50 MPa to 110 MPa, from 50 MPa to 105 MPa, from 50 MPa to 100 MPa, from 50 MPa to 95 MPa, from 60 MPa to 120 MPa, from 60 MPa to 115 MPa, from 60 MPa to 110 MPa, from 60 MPa to 105 MPa, from 60 MPa to 100 MPa, from 60 MPa to 95 MPa, from 65 MPa to 120 MPa, from 65 MPa to 115 MPa, from 65 MPa to 110 MPa, from 65 MPa to 105 MPa, from 65 MPa to 100 MPa, from 65 MPa to 95 MPa, from 70 MPa to 120 MPa, from 70 MPa to 115 MPa, from 70 MPa to 110 MPa, from 70 MPa to 105 MPa, from 70 MPa to 100 MPa, from 70 MPa to 95 MPa, from 75 MPa to 120 MPa, from 75 MPa to 115 MPa, from 75 MPa to 110 MPa, from 75 MPa to 105 MPa, from 75 MPa to 100 MPa, from 75 MPa to 95 MPa, from 80 MPa to 120 MPa, from 80 MPa to 115 MPa, from 80 MPa to 110 MPa, from 80 MPa to 105 MPa, from 80 MPa to 100 MPa, from 80 MPa to 95 MPa, from 85 MPa to 120 MPa, from 85 MPa to 115 MPa, from 85 MPa to 110 MPa, from 85 MPa to 105 MPa, from 85 MPa to 100 MPa, from 85 MPa to 95 MPa, from 90 MPa to 120 MPa, from 90 MPa to 115 MPa, from 90 MPa to 110 MPa, from 90 MPa to 105 MPa, from 90 MPa to 100 MPa, from 90 MPa to 95 MPa, from 95 MPa to 120 MPa, from 95 MPa to 115 MPa, from 95 MPa to 110 MPa, from 95 MPa to 105 MPa, from 95 MPa to 100 MPa, from 100 MPa to 120 MPa, or any and all sub-ranges formed from any of these endpoints. In embodiments, the cladding layers 104a, 104b each have a compressive stress of greater than 50 MPa and less than 110 MPa, or greater than 80 MPa and less than 110 MPa. However, it is contemplated that the compressive stress in each of the cladding layers 104a, 104b can vary depending on the particular embodiment, and may be greater than 110 MPa or less than 80 MPa or greater than 110 MPa or less than 50 MPa.

As described above, when the CTE_{core} is greater than the CTE_{clad} (either as averaged over a temperature range or at the lower of the T₁₁ temperatures), the core layer 102 is under a tensile stress. In various embodiments, prior to any treatments, the core layer 102 has a tensile stress of greater than 10 MPa and less than 75 MPa. In embodiments, the core layer 102 has a tensile stress of greater than 10 MPa, greater than 15 MPa, greater than 20 MPa, greater than 25 MPa, greater than 30 MPa, greater than 35 MPa, or greater than 40 MPa. In embodiments, the core layer 102 has a tensile stress of less than 75 MPa, less than 70 MPa, less than 65 MPa, or less than 60 MPa prior to any surface treatments. The core layer can have a tensile stress, for example, from 10 MPa to 75 MPa, from 10 MPa to 70 MPa, from 10 MPa to 65 MPa, from 10 MPa to 60 MPa, from 15 MPa to 75 MPa, from 15 MPa to 70 MPa, from 15 MPa to 65 MPa, from 15 MPa to 60 MPa, from 20 MPa to 75 MPa, from 20 MPa to 70 MPa, from 20 MPa to 65 MPa, from 20 MPa to 60 MPa, from 25 MPa to 75 MPa, from 25 MPa to 70 MPa, from 25 MPa to 65 MPa, from 25 MPa to 60 MPa, from 30 MPa to 75 MPa, from 30 MPa to 70 MPa, from 30 MPa to 65 MPa, from 30 MPa to 60 MPa, from 35 MPa to 75 MPa, from 35 MPa to 70 MPa, from 35 MPa to 65 MPa, from 40 MPa to 75 MPa, from 40 MPa to 70 MPa, or any and all sub-ranges formed from any of these endpoints. However, it is contemplated that the tensile stress in the core layer 102 can vary depending on the particular embodiment, and may be greater than 75 MPa or less than 10 MPa. Following surface treatments, the core layer 102 may have the previously-recited tensile stress values at a midline of the core layer 102 as measured from the treated surface to the opposing surface.

In embodiments, one or both of the cladding layers 104a, 104b are each 5 microns to 325 microns thick, 5 microns to 300 microns thick, 10 microns to 275 microns thick, or 12 microns to 250 microns thick. In embodiments, one or both of the cladding layers 104a, 104b are each greater than 5 microns thick, greater than 10 microns thick, greater than 12 microns thick, greater than 15 microns thick, greater than 20 microns thick, greater than 25 microns thick, greater than 30 microns thick, greater than 40 microns thick, greater than 50 microns thick, greater than 60 microns thick, greater than 70 microns thick, greater than 80 microns thick, greater than 90 microns thick, greater than 100 microns thick, greater than 125 microns thick, greater than 150 microns thick, greater than 175 microns thick, or greater than 200 microns thick. In embodiments, one or both of the cladding layers 104a, 104b are each less than 325 microns thick, less than 300 microns thick, less than 275 microns thick, less than 250 microns thick, less than 225 microns thick, less than 200 microns thick, less than 175 microns thick, less than 150 microns thick, less than 125 microns thick, or less than 100 microns thick. It should be appreciated, however, that the cladding layers 104a, 104b can have other thicknesses.

According to embodiments described herein, the thickness of each of the cladding layers 104a, 104b is such that the compressive stress in each cladding layer extends to a depth of compression (DOC) of up to the thickness of the cladding layer 104a, 104b. In embodiments, the minimum DOC is selected to ensure that the glass substrate has a suitable strength even after the glass substrate is subjected to damage.

In embodiments, the core layer 102 has a thickness of from 200 μm to 1200 μm, from 300 μm to 1200 μm, or from 600 μm to 1100 μm. In embodiments, the core layer 102 has a thickness of greater than 200 μm, greater than 300 μm, greater than 500 μm, greater than 600 μm, greater than 700 μm, greater than 800 μm, greater than 900 μm. In embodiments, the core layer 102 has a thickness of less than 1200 μm, less than 1100 μm, less than 1000 μm, less than 900 μm, or less than 800 μm. For example, the core layer can have a thickness of from 200 μm to 1200 μm, from 200 μm to 1100 μm, from 200 μm to 1000 μm, from 200 μm to 900 μm, from 200 μm to 800 μm, from 300 μm to 1200 μm, from 300 μm to 1100 μm, from 300 μm to 1000 μm, from 300 μm to 900 μm, from 300 μm to 800 μm, from 500 μm to 1200 μm, from 500 μm to 1100 μm, from 500 μm to 1000 μm, from 500 μm to 900 μm, from 500 μm to 800 μm, from 600 μm to 1200 μm, from 600 μm to 1100 μm, from 600 μm to 1000 μm, from 600 μm to 900 μm, from 600 μm to 800 μm, from 700 μm to 1200 μm, from 700 μm to 1100 μm, from 700 μm to 1000 μm, from 700 μm to 900 μm, from 700 μm to 800 μm, from 800 μm to 1200 μm, from 800 μm to 1100 μm, from 800 μm to 1000 μm, from 800 μm to 900 μm, from 900 μm to 1200 μm, from 900 μm to 1100 μm, from 900 μm to 1000 μm, or any and all sub-ranges formed from any of these endpoints. It should be appreciated, however, that the core layer 102 can have other thicknesses.

Another aspect of the glass article 100 that can vary is the glass composition of the layers 102, 104a, 104b. For example, the layers 102, 104a, 104b can all be formed from different glass compositions or two of the layers can have the same glass composition while the third layer has a different glass composition. In general, one or both of the cladding layers 104a, 104b have a glass composition that is different than the glass composition of the core layer 102.

In embodiments, the glass composition for each of the cladding layers 104a, 104b, and the core layer 102 may be selected based on the CTE of the composition at a particular temperature (e.g., the T₁₁ temperature of the composition or the T₁₁ temperature of the composition of another layer) or its average CTE over a selected temperature range (e.g., 0° C. to 400° C., 0° C. to 300° C., 0° C. to 260° C., 20° C. to 300° C., or 20° C. to 260° C.), its density, its Young's modulus, its 200 Poise temperature, or other properties that may be desired for processing or use of the glass article. The 200 Poise temperature is the minimum temperature at which the glass has a viscosity of 200 Poise, which is indicative of a minimum temperature of a well-melted glass.

In embodiments, the glass compositions each have a liquidus viscosity suitable for forming the glass article 100 using a fusion draw process as described herein. For example, each of the glass compositions may have a liquidus viscosity of at least about 50 kP, at least about 70 kP at least about 100 kP, at least about 200 kP, or at least about 300 kP. Additionally or alternatively, each of the glass compositions comprises a liquidus viscosity of less than about 3000 kP, less than about 2500 kP, less than about 1000 kP, or less than about 800 kP.

It should be appreciated that numerous changes can be made to the embodiments of the glass article 100 shown in FIG. 2A. For example, in embodiments, the glass article 100 can include only three layers 102, 104a, 104b as depicted in FIG. 2A. In other embodiments, the glass article 100 can include four or more glass layers. Numerous other variations are also contemplated.

A variety of processes may be used to produce the glass articles 100 described herein including, without limitation, lamination slot draw processes, lamination float processes, or fusion lamination processes. Each of these lamination processes generally involves flowing a first molten glass composition, flowing a second molten glass composition, and contacting the first molten glass composition with the second molten glass composition at a temperature greater than the glass transition temperature of either glass composition to form an interface between the two compositions such that the first and second molten glass compositions fuse together at the interface as the glass cools and solidifies.

In one particular embodiment, the glass articles 100 described herein may be formed by a fusion lamination process such as the process described in U.S. Pat. No. 4,214,886, which is incorporated herein by reference. Referring to FIG. 2B by way of example, a laminate fusion draw apparatus 200 for forming a laminated glass article includes an upper overflow distributor or isopipe 202 which is positioned over a lower overflow distributor or isopipe 204. The upper overflow distributor 202 includes a trough 210 into which a molten glass clad composition 206 is fed from a melter (not shown). Similarly, the lower overflow distributor 204 includes a trough 212 into which a molten glass core composition 208 is fed from a melter (not shown).

As the molten glass core composition 208 fills the trough 212, it overflows the trough 212 and flows over the outer forming surfaces 216, 218 of the lower overflow distributor 204. The outer forming surfaces 216, 218 of the lower overflow distributor 204 converge at a root 220. Accordingly, the molten glass core composition 208 flowing over the outer forming surfaces 216, 218 rejoins at the root 220 of the lower overflow distributor 204 thereby forming a core layer 102 of a glass substrate 100.

Simultaneously, the molten glass clad composition 206 overflows the trough 210 formed in the upper overflow distributor 202 and flows over outer forming surfaces 222, 224 of the upper overflow distributor 202. The molten glass clad composition 206 is outwardly deflected by the upper overflow distributor 202 such that the molten glass clad composition 206 flows around the lower overflow distributor 204 and contacts the molten glass core composition 208 flowing over the outer forming surfaces 216, 218 of the lower overflow distributor, fusing to the molten glass core composition and forming the cladding layers 104a, 104b around the core layer 102.

The thickness of the core layer 102 and the cladding layers 104a, 104b, and therefore, the ratio of the thickness of the core layer to the total thickness of the glass cladding layers can be adjusted by controlling the flow of the molten glass core composition 208 and/or the molten glass clad composition 206 from the overflow distributors 202, 204, or other methods of controlling the thickness of a glass sheet as known to those skilled in the art. Alternatively, in embodiments, the ratio of the thickness of the core layer to the total thickness of the glass cladding layers can be adjusted or controlled by etching or polishing.

While FIG. 2B schematically depicts a particular apparatus for forming planar laminated glass articles such as sheets or ribbons, it should be appreciated that other geometrical configurations are possible. For example, cylindrical laminated glass articles and glass canes may be formed, for example, using the apparatuses and methods described in U.S. Pat. No. 4,023,953.

In embodiments described herein, the molten glass core composition 208 generally has a core low temperature coefficient of thermal expansion CTE_{core} or LTCTE_{core} which is greater than the clad low temperature coefficient of thermal expansion CTE_{clad} or LTCTE_{clad} of the molten glass clad composition 206, as described herein above. In embodiments described herein, the molten glass core composition 208 generally has a high temperature coefficient of thermal expansion HTCTE_{core} which is greater than the clad high temperature coefficient of thermal expansion HTCTE_{clad} of the molten glass clad composition 206, at the lower of the T₁₁ temperatures of the compositions, as described herein above. Accordingly, as the core layer 102 and the cladding layers 104a, 104b cool, the difference in the coefficients of thermal expansion of the core layer 102 and the cladding layers 104a, 104b cause compressive stresses to develop in the cladding layers 104a, 104b. The compressive stress increases the strength of the resulting glass article 100. Accordingly, the glass articles 100 described herein are mechanically strengthened through the lamination process.

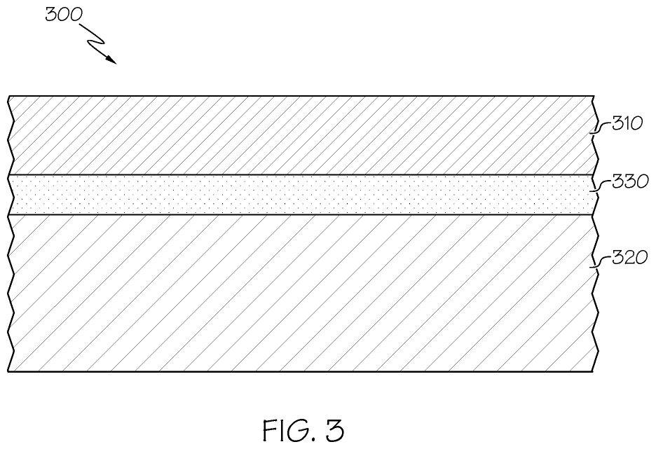

According to various embodiments, the glass article is strengthened by lamination with a polymer to form a glass-polymer laminate 300, as shown in FIG. 3. As with the lamination of multiple glass layers described above, in embodiments, the CTE of the glass layer 310 and the CTE of the polymer 320 are substantially different. For example, the CTE of the glass layer 310 may be less than the CTE of the polymer 320. Accordingly, the CTE mismatch between the glass layer 310 and the polymer layer 320 can impart stress in the glass layer 310 to strengthen the glass layer 310, as described above.

In FIG. 3, the glass-polymer laminate 300 comprises a glass layer 310, a polymer layer 320, and an adhesive layer 330 disposed between the glass layer 310 and the polymer layer 320. Thus, the polymer layer 320 is laminated to the glass layer 310 with the adhesive layer 330. However, it is contemplated that in embodiments, the polymer layer 320 may be laminated to the glass layer 310 without the use of an adhesive layer.

The glass layer 310 can have a thickness of at most about 325 μm, at most about 300 μm, at most about 200 μm, at most about 150 μm, or at most about 100 μm. Additionally or alternatively, the glass layer 310 can have a thickness of at least about 50 μm. For example, the glass layer 310 may have a thickness of from 150 μm to 250 μm, including all ranges and sub-ranges within. Other thickness are also contemplated for the glass layer 310, depending on the particular embodiment.

In embodiments, the glass layer 310 comprises a glass material, a ceramic material, a glass-ceramic material, or combinations thereof. For example, the glass layer 310 may comprise any of the compositions described hereinabove. The glass layer 310 may be formed using any suitable forming process, such as a downdraw process such as a fusion process. Forming the glass layer 310 using a fusion process can enable the glass layer to have surfaces with superior flatness and smoothness compared to glass sheets produced by other methods. The fusion process is described in U.S. Pat. Nos. 3,338,696 and 3,682,609, each of which is hereby incorporated by reference in its entirety. Other suitable glass forming processes may include float processes, updraw processes, or slot draw processes.

According to various embodiments, the polymer layer 320 has a thickness of at least about 2 mm, at least about 3 mm, at least about 4 mm, or at least about 5 mm. Additionally or alternatively, the polymer layer 320 has a thickness of at most about 10 mm, at most about 9 mm, at most about 8 mm, at most about 7 mm, or at most about 6 mm. For example, the polymer layer 320 may have a thickness of from 2.9 mm to 6.1 mm, from 3.9 mm to 6.1 mm, or from 5.1 mm to 6.1 mm, including all ranges and sub-ranges within. Other thickness are also contemplated for the polymer layer 320, depending on the particular embodiment. The polymer layer 320 may comprise a polymer material such as, by way of example and not limitation, polyethylene terephthalate (PET), polyethylene naphthalate (PEN), ethylene tetrafluoroethylene (ETFE), thermopolymer polyolefin (TPOTM—polymer/filler blends of polyethylene, polypropylene, block copolymer polypropylene (BCPP), or rubber), polyester, polycarbonate, polyvinylbuterate, polyvinyl chloride (PVC), polyethylene or substituted polyethylene, polyhydroxybutyrate, polyhydroxyvinyl butyrate, polyvinyl acetylene, transparent thermoplastic, transparent polybutadiene, polycyanoacrylate, cellulose-based polymer, polyacrylate, polymethacrylate, polyvinylalcohol (PVA), polysulphide, polyvinyl butyral (PVB), poly(methyl methacrylate) (PMMA), polysiloxane, or combinations thereof. Other polymers are contemplated for the polymer layer 320, provided that they do not substantially increase the dielectric constant or dielectric loss tangent at 28 GHz, 30 GHz, 38 GHz, or other range of interest. The polymer layer 320 can comprise a single layer or multiple layers laminated together to form the polymer layer 320.

The adhesive layer 330 may have a thickness of at least about 10 μm, at least about 20 μm, at least about 30 μm, or at least about 40 μm. Additionally or alternatively, the adhesive layer 330 may have a thickness of at most about 100 μm, at most about 90 μm, at most about 70 μm, or at most about 60 μm. For example, the adhesive layer 330 may have a thickness of from 25 μm to 75 μm, including all ranges and sub-ranges within. Other thickness are also contemplated for the adhesive layer 330, depending on the particular embodiment.

In embodiments, the adhesive layer 330 comprises a non-adhesive interlayer, a sheet or film of adhesive, a liquid adhesive, a powder adhesive, a pressure sensitive adhesive, an ultraviolet (UV) curable adhesive, a thermally curable adhesive, another suitable adhesive, or combinations thereof. For example, the adhesive layer 330 may comprise a low temperature adhesive, a silicone adhesive, an acrylate adhesive, a polyurethane adhesive, a high temperature adhesive, a solvent-based adhesive, or a solventless adhesive. In embodiments, the adhesive layer 330 is optically clear on cure.

The polymer layer 320 can be laminated to the glass layer 310 using a suitable lamination process to form the glass-polymer laminate 300. For example, the polymer layer 320 can be laminated to the glass layer 310 using a sheet-to-sheet (S2S) lamination process wherein pressure and/or heat are used to bond the glass layer to the polymer layer using the adhesive layer. Alternatively, the polymer layer can be laminated to the glass layer using a roll-to-sheet (R2S) or roll-to-roll (R2R) lamination process wherein pressure is used to bond a continuous ribbon of the glass layer from a supply roll to the polymer layer either as a continuous ribbon from a supply roll or a plurality of individual sheets. The lamination process can be controlled to impart desired properties to the glass-polymer laminate, as will be understood by one of skill in the art.

In some embodiments, the glass layer 310 comprises a LTCTE of at least about 0.5×10⁻⁶/° C., at least about 1×10⁻⁶/° C., at least about 1.5×10⁻⁶/° C., at least about 2×10⁻⁶/° C., at least about 2.5×10⁻⁶/° C., or at least about 3×10⁻⁶/° C. Additionally, or alternatively, the glass layer 310 comprises a LTCTE of at most about 9×10⁻⁶/° C., at most about 8×10⁻⁶/° C., at most about 7×10⁻⁶/° C., at most about 6×10⁻⁶/° C., at most about 5×10⁻⁶/° C., or at most about 4×10⁻⁶/° C. For example, the glass layer 310 comprises a LTCTE of about 2.7×10⁻⁶/° C. to about 3.7×10⁻⁶/° C., including all ranges and sub-ranges within.

In some embodiments, the glass layer 310 comprises a HTCTE of at least about 11×10⁻⁶/° C., at least about 11.5×10⁻⁶/° C., at least about 12×10⁻⁶/° C., at least about 12.5×10⁻⁶/° C., at least about 13×10⁻⁶/° C., or at least about 13.5×10⁻⁶/° C. Additionally, or alternatively, the glass layer 310 comprises a HTCTE of at most about 25×10⁻⁶/° C., at most about 22.5×10⁻⁶/° C., at most about 21×10⁻⁶/° C., or at most about 20×10⁻⁶/° C. For example, the glass layer 310 comprises a HTCTE of about 12×10⁻⁶/° C. to about 22×10⁻⁶/° C., including all ranges and sub-ranges within.

In some embodiments, the polymer layer 320 comprises a CTE of at least about 20×10⁻⁶/° C., at least about 30×10⁻⁶/° C., at least about 40×10⁻⁶/° C., at least about 50×10⁻⁶/° C., at least about 60×10⁻⁶/° C., or at least about 70×10⁻⁶/° C. Additionally, or alternatively, the polymer layer 320 comprises a CTE of at most about 130×10⁻⁶/° C., at most about 120×10⁻⁶/° C., at most about 110×10⁻⁶/° C., at most about 100×10⁻⁶/° C., at most about 90×10⁻⁶/° C., or at most about 80×10⁻⁶/° C. For example, the polymer layer 320 comprises a CTE of about 74.5×10⁻⁶/° C. to about 75.5×10⁻⁶/° C., including all ranges and sub-ranges within.

In some embodiments, the difference in CTE or CTE mismatch between the glass layer 310 and the polymer layer 320 is at least about 10×10⁻⁶/° C., at least about 20×10⁻⁶/° C., at least about 30×10⁻⁶/° C., at least about 40×10⁻⁶/° C., at least about 50×10⁻⁶/° C., at least about 60×10⁻⁶/° C., or at least about 70×10⁻⁶/° C., including all ranges and sub-ranges within.

Although various methods of strengthening glass articles, including thermal tempering and mechanical strengthening, have been described herein, it is contemplated that other known methods of strengthening glass articles may be employed, provided they do not increase the dielectric constant or dielectric loss tangent of the glass article at 28 GHz, 30 GHz, 38 GHz, or other range of interest, or require materials that would interfere with the operation of the electronic device.

### Devices and Products Incorporating Strengthened Glass Articles

The strengthened glass articles discussed herein have a wide range of uses in a wide range of articles, devices, products, structures, and the like. In embodiments, the strengthened glass article may be used on any surface of electronic devices, mobile phones portable media players, televisions, notebook computers, watches, user wearable devices (e.g., activity trackers), camera lenses, camera displays, household appliances, tablet computer displays, and any other electronic device.

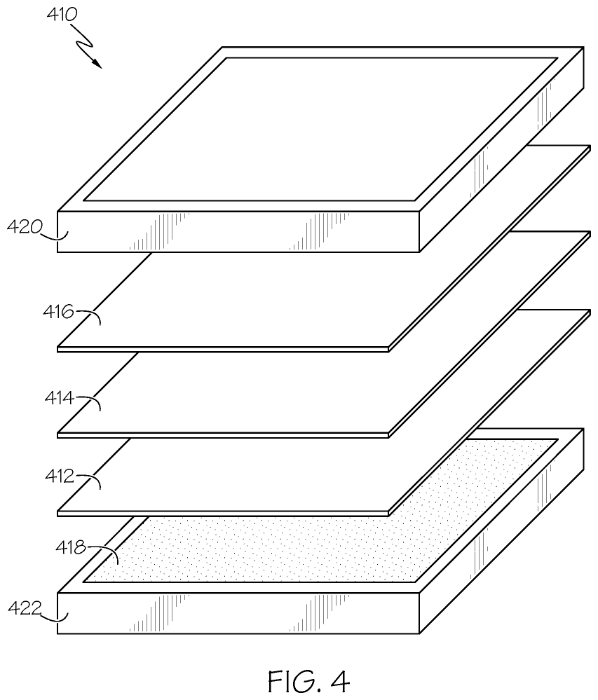

Referring to FIG. 4, a device 410 (e.g., a handheld computer, tablet, portable computer, cellular phone, etc.) includes one or more strengthened glass articles 412, 414, 416, manufactured as disclosed herein, and further includes electronic components 418 (e.g., a display, an electronic display, a controller, a memory, a microchip, etc.) and a housing 420. In embodiments, the electrical components 418 and/or the electronic display may include a liquid crystal display and/or at least one light emitting diode (LED). In embodiments, the electronic display may be a touch sensitive display. In further embodiments, the glass layer forming or covering the electronic display may include a surface feature on the first or second major surface for haptic feedback for a user. For example, raised projections, ridges, contours, or bumps are non-limiting example surface features for haptic feedback.

In embodiments, the electrical components 418 are provided at least partially within the housing 420 and, in some embodiments, may be provided completely within the housing 420. In embodiments, the housing 420 may be or include a strengthened glass article as described herein. In embodiments, a substrate 422 for the electronic components 418 may be a strengthened glass article as described herein.

In some embodiments, the strengthened glass articles 412, 414 may function as frontplane and backplane substrates, and the strengthened glass article 416 may function as a cover glass in the device 410. According to various embodiments, the strengthened glass article 416 may be particularly thin or otherwise structures, such as having any dimensions, properties, and/or compositions as disclosed herein.

In embodiments, the housing 420 may include a front surface, a back surface, and at least one side surface. The housing 420 may include one or more glass-based layers including strengthened glass articles as disclosed herein. The glass-based layer (e.g., 412, 414, and 416) may form any surface of a consumer electronic product. In one or more embodiments, the glass-based layer extends across the housing front surface from at least one side surface to an opposite side surface. In embodiments, the glass-based layer is provided at or adjacent the front surface of the housing 420. In further embodiments, the glass-based layer may include a surface feature on the first or second major surface for haptic feedback for a user. In embodiments, the glass-based layer (e.g., 412, 414, 416) may be shaped in 1-dimension, 2-dimensions, 2.5-dimensions (e.g., curvature at the edge of a display glass), or 3-dimensions.

The cover glass or glass-ceramic article may include a glass material that is substantially optically clear, transparent, and free from light scattering. In such embodiments, the cover glass material may exhibit an average light transmission over a wavelength range from 400 nm to about 780 nm of about 85% or greater, about 86% or greater, about 87% or greater, about 88% or greater, about 89% or greater, about 90% or greater, about 91% or greater, or about 92% or greater. The glass material may optionally exhibit a color, such as white, black, red, blue, green, yellow, orange, etc.

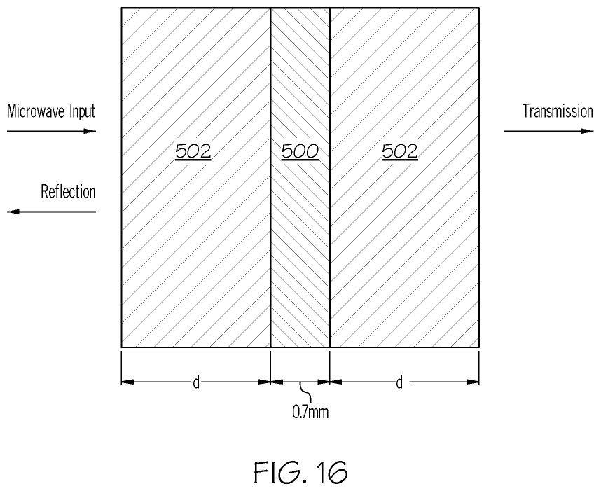

In embodiments, the glass-based layer can include a glass article 500 positioned between two wave layers 502, sometimes referred to herein as a quarter wavelength transformer, as shown in FIG. 16. The wave layers 502 can, for example, improve transmission of radio frequencies by reducing a cavity effect of wavelengths passing through the glass substrate, as will be described in greater detail below. The wave layers 502 can have a thickness that depends on the particular wavelength of interest (e.g., the operational frequency of the device) and the dielectric constant of the material being used for the wave layers 502.

Due to limitations on the dielectric constants available (e.g., because of the finite materials available), the thickness of the quarter wavelength transformer may be selected according to Equation (1), where d is the thickness of the material, λ₀ is the microwave wavelength in a vacuum, and εᵣ is the relative dialectic constant of the material.

$$d = \frac{{λ}_{0}}{4 \sqrt{{ε}_{r}}} \qquad ( 1 )$$

The microwave wavelength λ₀ refers to the radio-frequency that is used, and is equal to 3e8/ƒ; where ƒ is the frequency of the operation of the device. In embodiments, when the glass-based layer is configured as shown in FIG. 16 with two wave layers, the thickness d of each wave layer 502 is from

$$\frac{0.8 {λ}_{o}}{4 \sqrt{{ε}_{r}}} to \frac{1.2 {λ}_{o}}{4 \sqrt{{ε}_{r}}} .$$

When included, the wave layer 502 may be a plastic or glass having a dielectric constant that is less than the dielectric constant of the glass article 500. For example, the wave layer 502 can be formed from, by way of example and not limitation, silica, polyethylene terephthalate (PET), polyimide, polymethylmethacrylate/acrylic (PMMA), polyethylene (PE), polycarbonate (PC), acrylonitrile butadiene styrene (ABS), fluorinated ethylene propylene (FEP), or polytetrafluoroethylene (PTFE).

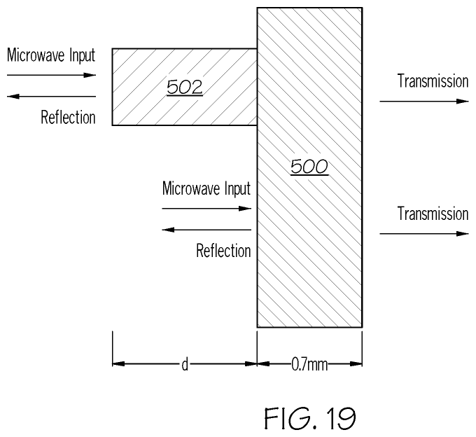

In embodiments, the thickness of the housing 420 may be limited. Accordingly, to reduce the thickness of the glass-based layer and, therefore, the housing 420, in embodiments, a wave layer 502 may be positioned directly adjacent to and in contact with one surface of the glass substrate 500, as shown in FIG. 19. The wave layer 502 in FIG. 19 may sometimes be referred to as a “matching layer,” and may be present between the antenna of the device 410 and the glass article 500. In embodiments, when the glass-based layer is configured as shown in FIG. 19 with a wave layer present on one side of the glass article, the thickness d of the wave layer is from

$$\frac{1.1 {λ}_{o}}{4 \sqrt{{ε}_{r}}} to \frac{1.5 {λ}_{o}}{4 \sqrt{{ε}_{r}}} .$$

Thus, although the thickness d of the wave layer in FIG. 19 is thicker than a single wave layer in FIG. 16, the overall thickness of the glass-based layer is reduced.

Although it is desirable for the wave layer 502 to have a dielectric constant that is lower than the dielectric constant of the glass article 500, in embodiments, the wave layer 502 may have a dielectric constant that is similar to (e.g., +/−10% of) the dielectric constant of the glass article. In such embodiments, when the glass-based layer is configured as shown in FIG. 19 with a wave layer present on one side of the glass article, the thickness of the glass-based layer (including the wave layer and the glass substrate) is

$$\frac{0.8 {λ}_{o}}{4 {ε}_{r}} to \frac{1.2 {λ}_{o}}{4 {ε}_{r}} .$$

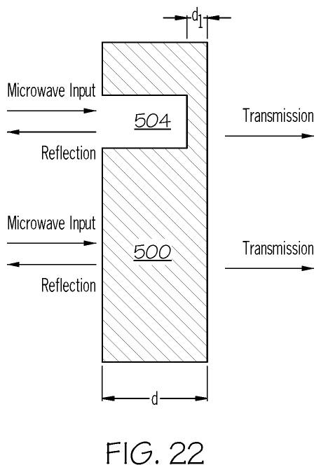

In embodiments, transmission may be improved by removing material from the glass article, as shown in FIG. 22. In FIG. 22, material is removed from the glass article 500 to form a pocket 504. Accordingly, the glass article 500 has a region with a smaller thickness d₁ (sometimes referred to as a “window thickness”) as compared to the thickness d of the glass article 500 where material was not removed. In embodiments, d₁ may be less than or equal to about 20% of the original thickness d (e.g., d₁≤0.2d), where the original thickness d is greater than 400 μm and the smaller thickness d₁ is less than 400 μm. Material can be removed, for example, by etching, grinding, cutting, polishing, machining, or laser ablation.

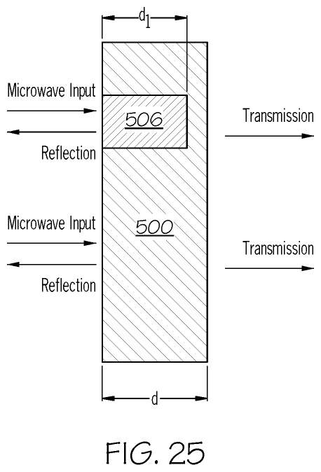

In embodiments, to provide additional strength, the pocket 504 may be filled with a filling 506 formed from a different material, as shown in FIG. 25. The material can be any one of a number of suitable materials, and, in embodiments, is a material having a dielectric constant of from about 2.0 to about 6.0. Suitable materials for the filling 504 can include, by way of example and not limitation, polyethylene terephthalate (PET), polyimide, polymethylmethacrylate/acrylic (PMMA), polyethylene (PE), polycarbonate (PC), acrylonitrile butadiene styrene (ABS), fluorinated ethylene propylene (FEP), or polytetrafluoroethylene (PTFE). Accordingly, the filling 504 can mechanically strengthen the area having the reduced thickness, while improving transmission of the frequencies through the glass-based layer. Such configurations may also enable glass articles having higher dielectric constants (e.g., dielectric constants of from 5.0-9.0) to be used within a device 410 with improved transmission as compared to a conventional glass article having the same dielectric constant and thickness.

### EXAMPLES

The following examples illustrate one or more additional features of the present disclosure described previously. It should be understood that these examples are not intended to limit the scope of the disclosure or the appended claims in any manner.

### Example 1

Various glass compositions, Samples 1-4 were selected as potential clad glass compositions and core glass compositions, each composition having a dielectric constant of less than 5 and a low loss tangent over the 5G frequency range (10-60 GHz). Corning® Eagle® XG (“EXG”) glass was also used as a potential clad glass composition. The dielectric properties for each of the glass compositions at various frequencies within the 5G frequency range are reported in Table 1 below.

TABLE 1
Table 1: Dielectric Properties of Sample Glass Compositions

| f | EXG | | Sample 1 | | Sample 2 | | Sample 3 | | Sample 4 | |
|---|---|---|---|---|---|---|---|---|---|---|
| (GHz) | Dk | tan δ | Dk | tan δ | Dk | tan δ | Dk | tan δ | Dk | tan δ |
| 10 | 5.15 | 0.006 | 4.78 | 0.0031 | 4.6 | 0.0037 | 4.5 | 0.005 | 4.84 | 0.0031 |
| 20 | 5.15 | 0.007 | — | — | 4.6 | 0.0043 | 4.5 | 0.006 | 4.84 | 0.0037 |
| 30 | 5.15 | 0.0077 | — | — | 4.6 | 0.0048 | 4.5 | 0.0065 | 4.83 | 0.0041 |
| 40 | 5.15 | 0.0084 | — | — | 4.6 | 0.0052 | 4.5 | 0.0071 | 4.8 | 0.0044 |
| 50 | 5.15 | 0.0086 | — | — | 4.6 | 0.0056 | 4.5 | 0.0077 | 4.8 | 0.0046 |
| 60 | 5.15 | 0.0097 | — | — | 4.6 | 0.0058 | 4.5 | 0.0082 | 4.83 | 0.0052 |

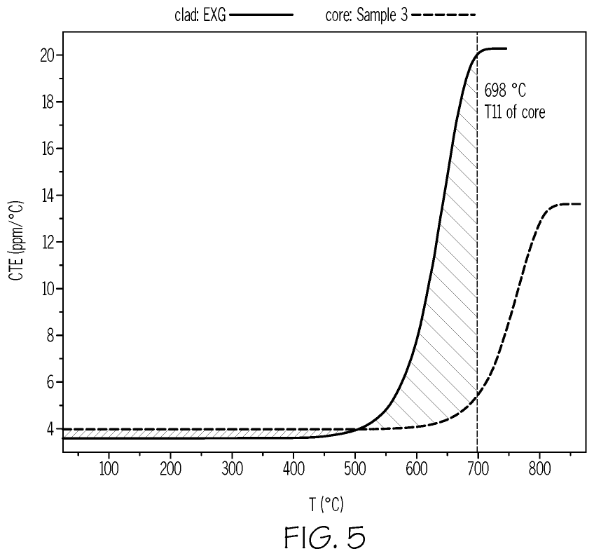

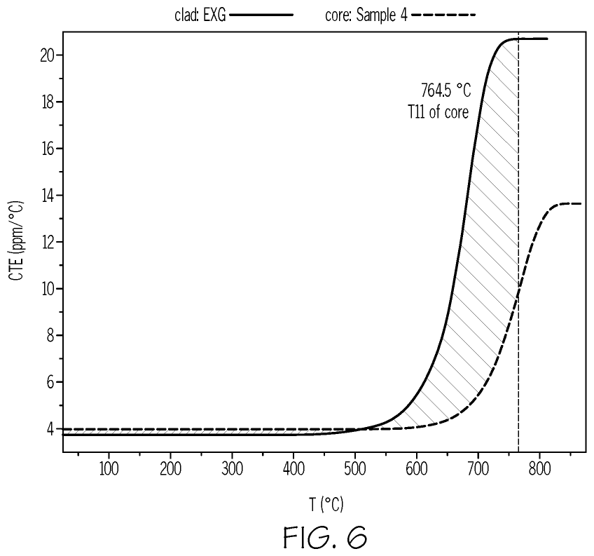

CTE curves for a potential pairing of EXG (clad) and Sample 3 (core) are shown in FIG. 5, and CTE curves for a potential pairing of EXG (clad) and Sample 4 (core) are shown in FIG. 6. As can be seen in FIGS. 5 and 6, although the glass compositions for each potential pairing have a similar CTE over the low temperature range (25° C. to about 400° C.), at the T₁₁ temperature of the core glass (698° C. for Sample 3 and 764.5° C. for Sample 4), the CTE mismatch is quite large.

Equations to estimate the stress in the clad (σ_{clad}) and the core (σ_{core}) were developed, and are presented in Equations (2) and (3) below, in which α(T) is CTE as a function of temperature, E is Young's modulus, v is Poisson's ratio. In Equations (2) and (3), k is the thickness ratio of the lamination with t as the thickness, as shown in Equation (4) below. Since a certain portion of stress build up at high temperature is relaxed during cooling, a stress relaxation function ƒ(T) (Equation 5 below) is added, where h is a parameter controlling the transition and is set equal to 10 to match experimental data.

$${σ}_{clad} = \frac{{\int }_{25}^{T 11} [ {α}_{clad} ( T ) - {α}_{core} ( T ) ] \cdot f ( T ) \cdot dT}{\frac{1 - {v}_{core}}{{kE}_{core}} + \frac{1 - {v}_{clad}}{{E}_{core}}} \qquad ( 2 )$$

$${σ}_{core} = \frac{{\int }_{25}^{T 11} [ {α}_{core} ( T ) - {α}_{clad} ( T ) ] \cdot f ( T ) \cdot dT}{\frac{1 - {v}_{core}}{{kE}_{core}} + \frac{k ( 1 - {v}_{clad} )}{{E}_{clad}}} \qquad ( 3 )$$

$$k = \frac{{t}_{core}}{2 {t}_{clad}} \qquad ( 4 )$$

$$f ( T ) = \frac{1}{1 + {e}^{- 2 h \frac{( {T}_{strain} + \frac{{T}_{11} - {T}_{strain}}{2} ) - T}{{T}_{11} - {T}_{strain}}}} \qquad ( 5 )$$

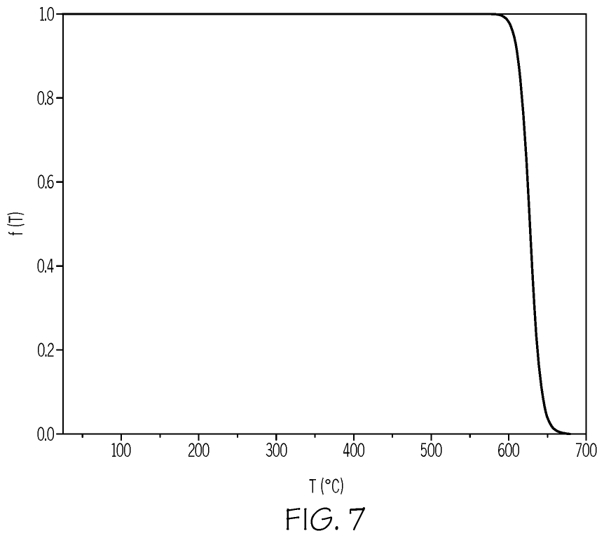

The stress relaxation as a function of temperature for a glass laminate including EXG (clad) and Sample 3 (core) is shown in FIG. 7. As shown in FIG. 7, at high temperature near T₁₁, ƒ(T) is close to 0, suggesting that most of laminate stress would be fully relaxed. As temperature decreases, ƒ(T) increases, and less stress relaxation happens. As the glass cooled below 600° C., ƒ(t) is close to 1, suggesting no stress relaxation. FIG. 7 also shows that the laminate can undergo thermal cycling through temperatures of up to about 600° C. without losing stress, confirming that the glass laminate is stable at low temperatures.

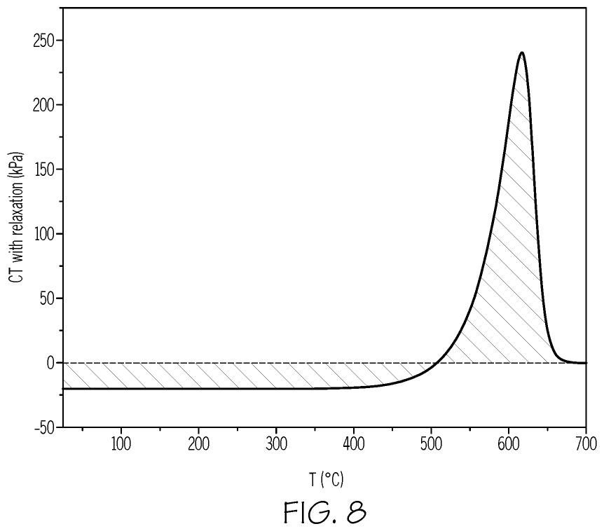

For the glass laminate including EXG (clad) and Sample 3 (core), the stress (shown as central tension) in the core as a function of temperature, including relaxation, is plotted in FIG. 8, and a full integration from T₁₁ to 25° C. gives the stress of the laminate in the core glass. In FIG. 8, when the central tension is less than 0, compressive stress is present.

To confirm Equations (2)-(5), laminates were made using EXG (clad) and Sample 3 (core) and EXG (clad) and Sample 4 (core) on a micro laminate fusion draw apparatus. Each laminate had a total thickness of 1 mm and a thickness ratio of 0.6. Tension in the core layer (CT) was measured by scattered light polariscope (SCALP), P), and then the compressive stress (CS) was calculated by force balancing (CT*t_{core}=CS*2t_{clad}) where tore is thickness of the core layer, and t_{core} t_{clad} is the thickness of single side clad. The stresses in the glass make the glass birefringent due to the photoelastic effect. Accordingly, the measured optical retardation distribution was recorded and plotted. The calculated laminate stress values are provided in Table 2. The glass properties used for calculating the laminate stresses are provided in Table 3.

For Laminate A, a central tension of 7.1 MPa was measured in the core and a compressive stress of 4.3 MPa was measured in the clad. For Laminate B, a central tension of 20 MPa was measured in the core and a compressive stress of 13 MPa was measured in the clad. Comparing the measured central tension and compressive stress values to the calculated values, the model was determined to be suitable for use.

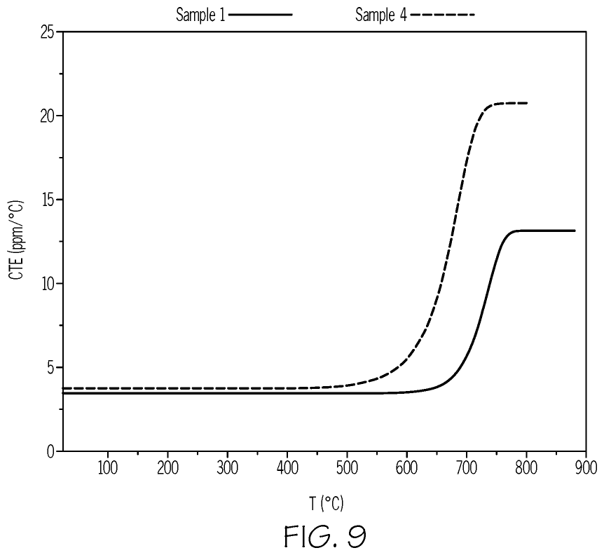

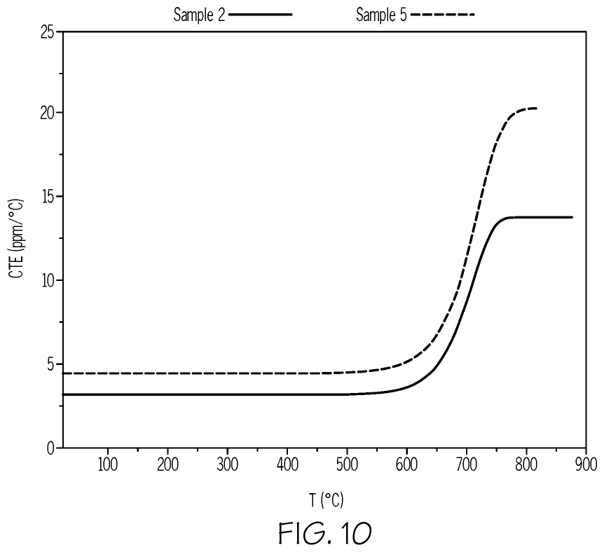

Upon confirming the equations, stress values for additional laminates 1-4 and thickness ratios (k=0.6, 7, and 15) were calculated using Equations (2)-(5). Laminates 1-4 included glass Samples 1, 2, and 4, as well as new Sample 5. The calculated laminate stress values are provided in Table 2. The glass properties used for calculating the laminate stresses are provided in Table 3. Plots showing the ΔHTCTE for the glass compositions of Laminates 1 and 4 are shown in FIGS. 9 and 10, respectively.

TABLE 2
Table 2: Calculated Stress Values
for Laminates at Various k Values

| | k | | | 0.6 | 7 | 15 |
|---|---|---|---|---|---|---|
| Laminate | Core | Sample 3 | CT in core (MPa) | 5.2 | 1.1 | 0.6 |
| A | Clad | EXG | CS in clad (MPa) | 3.1 | 7.7 | 9 |
| Laminate | Core | Sample 4 | CT in core (MPa) | 29.3 | 6.2 | 3.1 |
| B | Clad | EXG | CS in clad (MPa) | 17.6 | 43.4 | 46.5 |
| Laminate | Core | Sample 4 | CT in core (MPa) | 47 | 9.8 | 4.9 |
| 1 | Clad | Sample 1 | CS in clad (MPa) | 28.2 | 68.6 | 73.5 |
| Laminate | Core | Sample 5 | CT in core (MPa) | 44.8 | 9.1 | 4.6 |
| 2 | Clad | Sample 1 | CS in clad (MPa) | 26.9 | 63.7 | 69 |
| Laminate | Core | Sample 4 | CT in core (MPa) | 45.6 | 9.3 | 4.6 |
| 3 | Clad | Sample 2 | CS in clad (MPa) | 27.4 | 65.1 | 69 |
| Laminate | Core | Sample 5 | CT in core (MPa) | 47.6 | 9.5 | 4.7 |
| 4 | Clad | Sample 2 | CS in clad (MPa) | 9.5 | 66.5 | 70.5 |

TABLE 3
Table 3: Glass Composition and Properties

| Glass (mol %) | EXG | Sample 1 | Sample 2 | Sample 3 | Sample 4 | Sample 5 |
|---|---|---|---|---|---|---|
| SiO2 | 67.49 | 68.9 | 69.4 | 66.70 | 64.64 | 59.9 |
| Al2O3 | 11.06 | 8.53 | 7.62 | 6.45 | 7.38 | 11 |
| B2O3 | 9.83 | 11.6 | 14 | 19.90 | 16.45 | 18 |
| Na2O | — | — | — | 0.89 | — | — |
| MgO | 2.26 | 4.92 | 3.48 | 0.52 | 2.21 | — |
| CaO | 8.76 | 5.89 | 5.36 | 4.85 | 8.14 | — |
| SrO | 0.5 | — | — | 0.51 | 1.11 | 11 |
| SnO2 | 0.08 | 0.12 | 0.12 | 0.11 | 0.07 | — |
| Total | 99.98 | 99.96 | 99.98 | 99.93 | 100 | — |
| Young's modulus (GPa) | 73.8 | 69.5 | 66.7 | 58.3 | 64.3 | 65.1 |
| Shear modulus (GPa) | 30.1 | 28.3 | 27.2 | 23.4 | 26.1 | 26.1 |
| Poisson's ratio | 0.223 | 0.228 | 0.224 | 0.246 | 0.232 | 0.248 |
| Density (g/cc) | 2.385 | 2.334 | 2.287 | 2.243 | 2.35 | 2.516 |
| Strain point (° C.) | 682.8 | 680.4 | 661.7 | 557.4 | 643.4 | 616 |
| Annealing point (° C.) | 734.6 | 745.1 | 745.4 | 615 | 696.4 | 668 |
| Softening point (° C.) | 970.6 | — | 1018.5 | 875.5 | — | 905.3 |

VFT parameters

| | | | | | | |
|---|---|---|---|---|---|---|
| A (Poise) | −2.056 | −2.254 | −1.715 | −2.750 | −2.054 | −3.249 |
| B | 4950 | 5720 | 4827 | 7668 | 5182 | 7207 |
| To (° C.) | 472.5 | 392.0 | 452.3 | 140.3 | 367.5 | 224.7 |
| *T₁₁ (° C.) | 851.6 | 823.5 | 831.9 | 698.0 | 764.5 | 730.5 |

*T₁₁ is calculated from VFT parameters.

As shown in Table 2, although Laminates A and B were used to confirm the stress modeling, even at increased k values, they did not exhibit a compressive stress suitable for use in consumer device applications. However, each of Laminates 1-4 exhibited a compressive stress of greater than 50 MPa, greater than 60 MPa, or greater than 65 MPa, at k values of 7, 15, or both.

Accordingly, Laminates 1-4 provide a glass laminate having a compressive stress of greater than 50 MPa throughout the thickness of the clad layer while also having a dielectric constant of less than 5 and a low loss tangent over the 5G frequency range (10-60 GHz). Compared to Corning Gorilla® glasses, which have a dielectric constant of between 6.5 and 7, Laminates 1-4 are expected to provide improved transmission in the 5G frequency range while also providing suitable damage resistance.

### Example 2

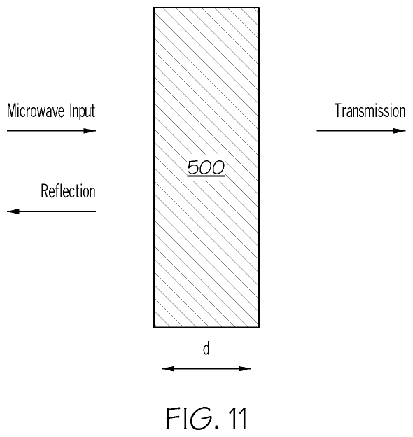

In order to assess dielectric constant values and, specifically, their behavior in terms of transmission and reflection, microwave radiation on a substrate having a thickness of 700 μm (0.7 mm) was analyzed computationally. The initial angle, θ₁, was zero (normal to the substrate), as shown in FIG. 11, and the range of frequencies was 0.5 GHz to 55 GHz. FIG. 11 is a schematic illustration of the arrangement in which the microwave beam in air find an initial air-glass interface, leading to a transmission (through the substrate) and a reflection (back toward the microwave beam source). After transmission through the substrate, the microwave beam finds a second glass-air interface, leading to another transmission and reflection. Thus, the substrate becomes a cavity in which multiple reflections occur on both sides of the substrate. The free spectral range (FSR) of the cavity can be defined with units in Hz according to Equation (6), where d is the thickness of the substrate, c is the velocity of the light in a vacuum, and εᵣ is the relative dialectic constant of the material.

$$FSR = \frac{c}{2 \sqrt{{ε}_{r} d}} \qquad ( 6 )$$

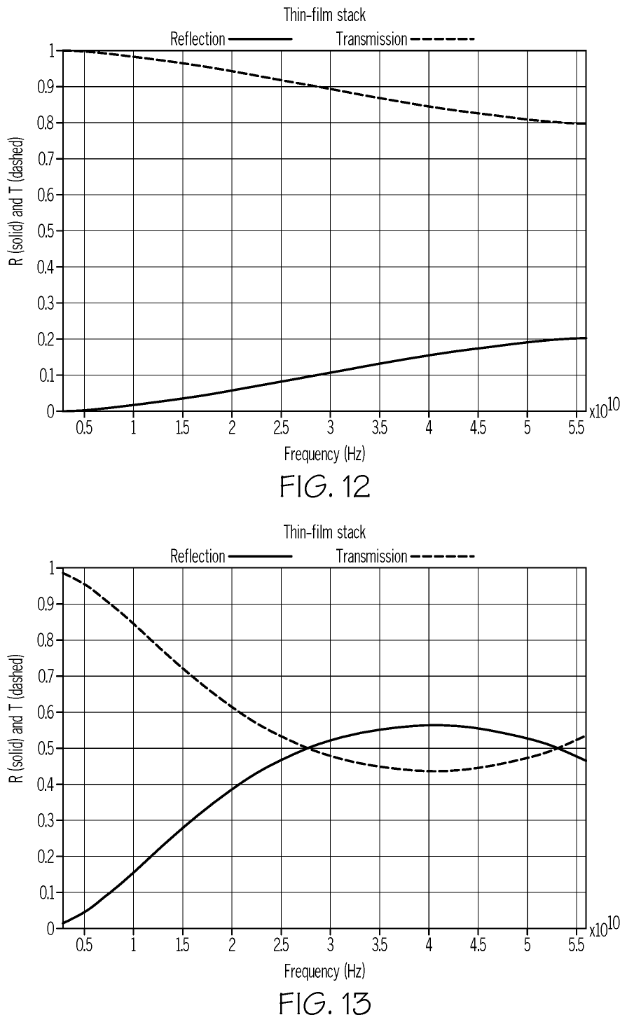

The FSR for a substrate having a dielectric constant of 2.7 (a dielectric constant in the range of a plastic material) was calculated using equation 6, and the FSR was about 130.4 GHz. The transmission (dashed line) and reflections (solid line) for this example substrate are shown in FIG. 12. As shown in FIG. 12, as the frequency increases, the transmission decreases. A minimum transmission is expected to occur at a frequency of FSR/2 (approximately 65.2 GHz), but is not shown in FIG. 12, since the simulation was performed only to a maximum frequency of 55 GHz. The plot in FIG. 12 shows that a substrate having a dielectric constant of 2.7 and a thickness of 0.7 mm exhibits a transmission of approximately 90% at the operational frequency of 28 GHz and a transmission of about 85% at the operational frequency of 38 GHz.

For comparison, the FSR for a substrate having a dielectric constant of 7.0 (a dielectric constant in the range of a conventional glass material) was calculated using equation 6, and the FSR was about 81.0 GHz. The transmission (dashed line) and reflections (solid line) for this example substrate are shown in FIG. 13. As shown in FIG. 13, the minimum transmission occurs at a frequency of FSR/2 (approximately 40.5 GHz). The plot in FIG. 13 shows that a substrate having a dielectric constant of 7.0 and a thickness of 0.7 mm exhibits a transmission of approximately 50% at the operational frequency of 28 GHz and a transmission of about 45% at the operational frequency of 38 GHz.

This illustrates the critical problem that depending on the thickness and dielectric constant one may be in a range of the transmission of the cavity, where a high dielectric constant leads to significant lower transmission losses for high dielectric constant materials.

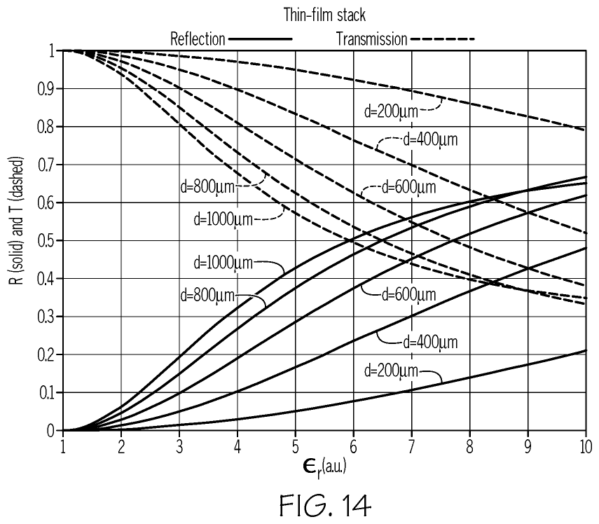

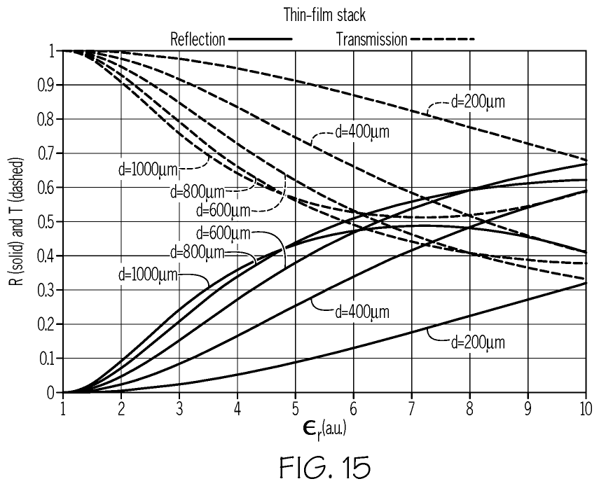

Next, the power transmission and reflection as a function of the relative dielectric constant were analyzed for substrates of thicknesses from 200 μm to 1000 μm. The initial angle, θ₁, was zero (normal to the substrate), as shown in FIG. 11. The resultant plots are shown for substrate thicknesses of 200 μm, 400 μm, 600 μm, 800 μm, and 1000 μm in FIG. 14 (28 GHz) and FIG. 15 (38 GHz).

As shown in FIG. 14, for the range of thicknesses from 200 μm to 1000 μm, the smaller the dielectric constant, the better the transmission values. In particular, in order to achieve a transmission of greater than 70%, the relative dielectric constant has to be smaller for a thicker substrate. In FIG. 15, similar to the FIG. 14, in order to achieve a transmission of greater than 70%, the relative dielectric constant has to be smaller for a thicker substrate. However, in order to achieve the same transmission of 70%, operation at 38 GHz requires a smaller relative dielectric constant as compared to 28 GHz, due to the smaller FSR at higher frequencies.

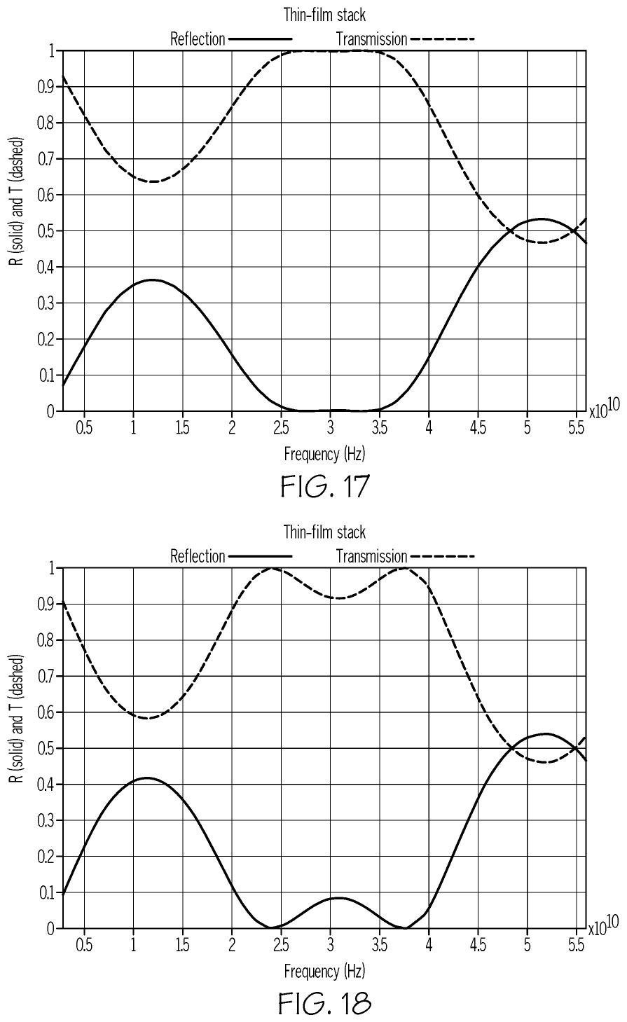

Accordingly, in an effort to improve the transmission performance at the dielectric interface, the use of quarter wavelength transformers was evaluated. By using a quarter wavelength transformer on both sides of the glass substrate, as shown in FIG. 16, it was found that the cavity effect can be reduced and the transmission can be increased. For analysis, the thickness of the glass was 0.7 mm, the initial angle, θ₁, was zero (normal to the substrate), as shown in FIG. 16, and the range of frequencies was 0.5 GHz to 55 GHz. Plots showing the reflections and transmissions for stacks using a plastic with a dielectric constant of 2.7 and a layer thickness d of 1.6 mm and pure silica with a dielectric constant of 3.5 and a layer thickness d of 1.4 mm are shown in FIGS. 17 and 18, respectively.

As shown in FIG. 17, the use of plastic with the dielectric constant of 2.7 as a quarter wavelength transformer resulted in a wide pass band that has a transmission close to 100% at 28 GHz and around 90% at 38 GHz with a significant flat pass-band in between. As shown in FIG. 18, the use of pure silica with the dielectric constant of 3.5 as a quarter wavelength transformer resulted in a wide pass band that has a transmission close to 92% at 28 GHz and around 98% at 38 GHz with a significant flat pass-band in between, which remains above 90%. Notably, the improvement in transmission provided by both of these materials was desirable, but the thickness added by the layers (3.2 mm for the plastic and 2.8 mm for the silica) may be problematic for some applications.

### Example 3

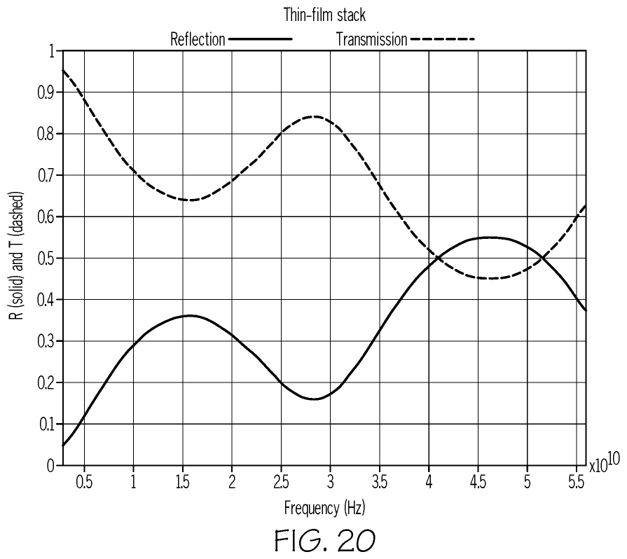

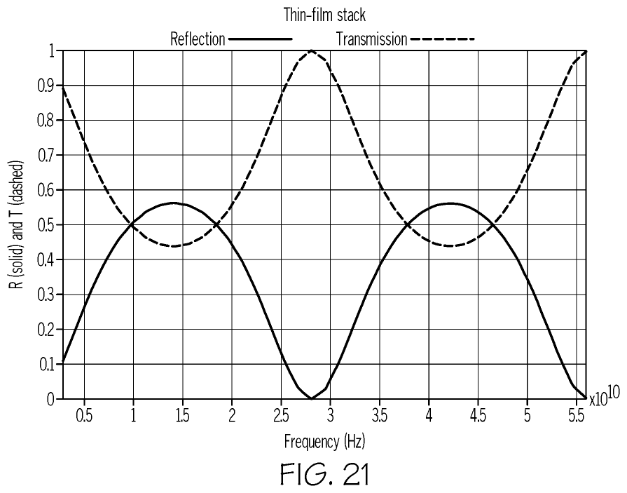

In an effort to reduce the thickness, the use of a matching layer was explored. In particular, the use of a matching layer on only one side of the glass, as shown in FIG. 19, and having a variable thickness was analyzed. For analysis, the thickness of the glass was 0.7 mm, the initial angle, θ₁, was zero (normal to the substrate), as shown in FIG. 19, and the range of frequencies was 0.5 GHz to 55 GHz. Plots showing the reflections and transmissions for stacks using a matching layer with a dielectric constant of 2.7 (e.g., plastic) and a layer thickness d of 1.83 mm and a matching layer formed from glass with a dielectric constant of 7.0 and a layer thickness d of 1.32 mm are shown in FIGS. 20 and 21, respectively.

In FIG. 20, the matching layer and glass substrate exhibited a transmission of approximately 80% at 28 GHz and approximately 50% at 38 GHz. Thus, although the thickness was reduced as compared to the previous example using a quarter wavelength transformer, transmission was decreased at both 28 GHz and 38 GHz.

In FIG. 21, the matching layer leads to a total half-wave layer and matches the FSR. Accordingly, at 28 GHz, 100% transmission is possible. However, at 38 GHz, the transmission drops to approximately 50%. Therefore, a matching layer of the same material as the substrate is possible, but unlikely to be able to match two or more wavelengths of operation simultaneously.

### Example 4

As an alternative to adding material to the glass substrate, removal of material from the glass substrate was also explored. FIG. 22 shows a schematic illustration of a substrate in which material has been removed to form a pocket. The pocket, for example, could be located in the region of a consumer device where microwave antennas are located to effectively provide a thinner glass substrate for microwave transmission. For analysis, various glass substrate thicknesses, d, were evaluated, using a window thickness, d₁, of 200 μm and an initial angle, θ₁, of zero (normal to the substrate), as shown in FIG. 22.

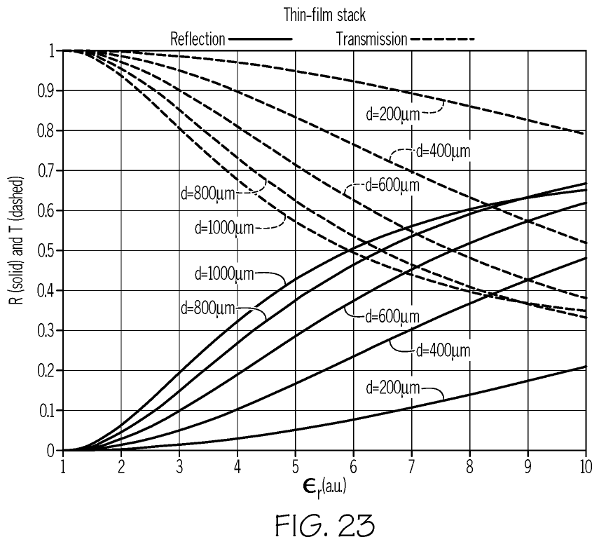

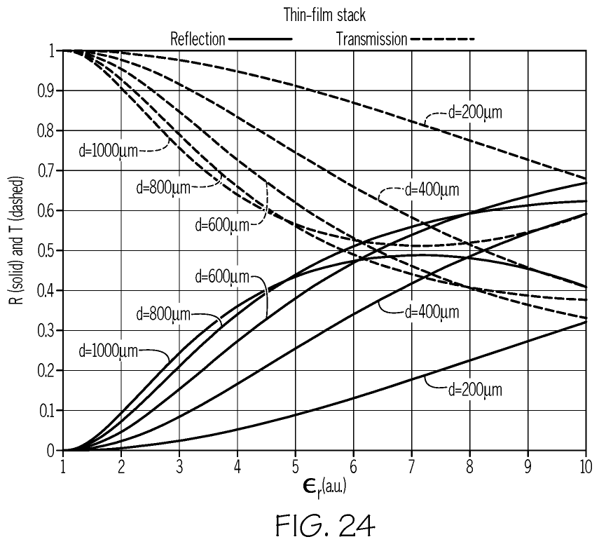

Transmission and reflection plots for varying thicknesses, d, at an operation frequency of 28 GHz are shown in FIG. 23. Transmission and reflection plots for varying thicknesses, d, at an operation frequency of 38 GHz are shown in FIG. 24.

As shown in FIG. 23, if the substrate is glass with a dielectric constant of 7.0, transmission improves from approximately 45% to approximately 90% for a substrate having a thickness of 800 μm and a window thickness of 200 μm. However, if the substrate is a glass or polymer with a dielectric constant of 4.0, transmission improves from approximately 72% to approximately 97%. At 38 GHz, as shown in FIG. 24, the same reduction in thickness from 800 μm to a window thickness of 200 μm results in an improvement in transmission from approximately 45% to approximately 82% for a substrate having a dielectric constant of 7.0, and from approximately 65% to approximately 94% for a substrate having a dielectric constant of 4.0. Accordingly, the removal of material from the substrate to create a transmission window can lead to improved transmission at both of the 5G operational frequencies without increasing the thickness.

Although the thinner window region depicted in FIG. 22 is advantageous in terms of electromagnetic transmission, it should be appreciated that the thin region will have an increased tendency to break during impact. Accordingly, an embodiment in which the pocket was filled with a solid having a low dielectric constant, such as a polymer, was analyzed. FIG. 25 schematically illustrates the configuration.

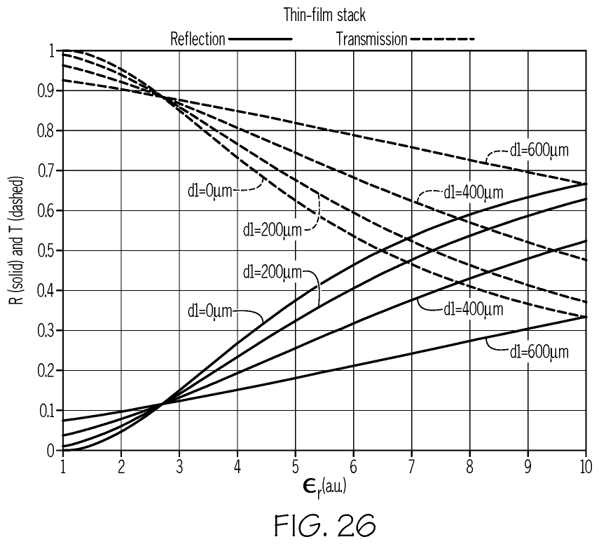

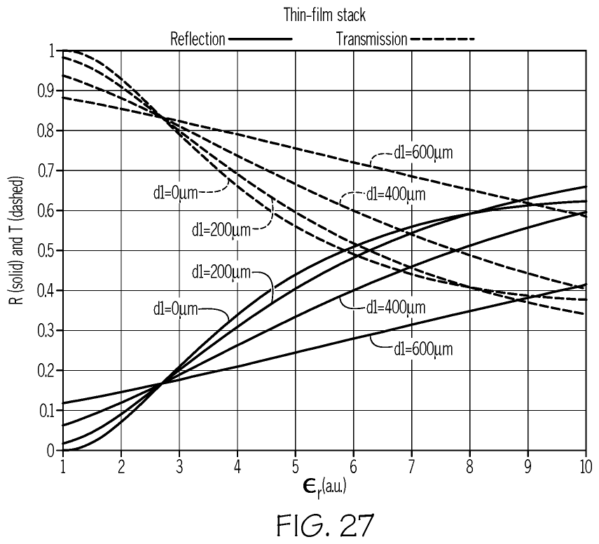

FIGS. 26 and 27 show the transmission and reflection plots for varying polymer thicknesses, d₁, at an operation frequency of 28 GHz and 38 GHz, respectively. For both analyses, the substrate had a total thickness, d, of 800 μm, an initial angle, θ₁, was zero (normal to the substrate), and the polymer had a dielectric constant of 2.7. By keeping the total thickness d constant, FIGS. 26 and 27 show the results where the thickness of the polymer is 0 μm, 200 μm, 400 μm, and 600 μm. By comparing the plot of d₁=0 μm with the plot of d₁=600 μm, one can determine the effect of the polymer.

For example, if the substrate is glass with a dielectric constant of 7.0, the incorporation of the polymer leads to an improvement of transmission from approximately 48% to approximately 78% at 28 GHz (FIG. 26) and from approximately 45% to approximately 70% at 38 GHz (FIG. 27). If, however, the substrate is glass with a dielectric constant of 4.0, the incorporation of the polymer leads to an improvement of transmission from approximately 73% to approximately 85% at 28 GHz (FIG. 26) and from approximately 66% to approximately 80% at 38 GHz (FIG. 27).

Although the inclusion of the polymer leads to a slight reduction in transmission as compared to constructions in which the pocket is left as a void (FIGS. 22-24), the combination of the polymer and the glass can provide improved mechanical stability while providing acceptable levels of transmission.

### Example 5

Glass having the composition of Sample 3 (Table 3, supra) was subjected to thermal tempering to determine if thermal tempering was effective to generate sufficient compressive stress for consumer device applications. The thermal tempering conditions, as well as fictive temperatures and the results of scratch and indentation performance of Sample 3 are presented in Table 4. The results of scratch and indentation performance of Comparative Samples A-D (conventional, lithium-containing, ion-exchanged glass) are presented in Table 5.

TABLE 4
Table 4: Thermal Tempering, Fictive Temperatures,
and Scratch and Indentation Performance of Sample 3

| | | | | | Surface |
|---|---|---|---|---|---|
| | | | | | Compres- |
| Tf | VIFT | VST | KST | | sion |
| (° C.) | (kg) | (N) | (N) | Tempering Conditions | (MPa) |
| 500 | 0.6 to 0.8 | 0 to 2 | 8 to 10 | N/A - HT 3x Structural | ~0 |
| | | | | Relaxation Time | |
| 550 | 0.6 to 0.8 | 0 to 2 | 10 to 12 | N/A - HT 3x Structural | ~0 |
| | | | | Relaxation Time | |
| 600 | 0.8 to 1.0 | 0 to 2 | 10 to 12 | N/A - HT 3x Structural | ~0 |
| | | | | Relaxation Time | |
| 650 | 0.8 to 1.0 | 0 to 2 | 12 to 14 | 650° C. - h = 0.036 | 1 |
| | | | | cal/(cm²-s) | |
| 700 | 1.0 to 1.2 | 0 to 2 | 16 to 18 | 700° C. - h = 0.036 | 5 |
| | | | | cal/(cm²-s) | |
| 750 | 1.8 to 2.0 | 2 to 4 | 16 to 18 | 790° C. - h = 0.038 | 45 |
| | | | | cal/(cm²-s) | |
| 800 | 2.0 to 3.0 | 4 to 6 | 8 to 10 | 830° C. - h = 0.107 | 90 |
| | | | | cal/(cm²-s) | |

TABLE 5
Table 5: Scratch and Indentation Performance
of Ion-Exchanged Glasses

| | | | | Surface |
|---|---|---|---|---|
| | VIFT | VST | KST | Compression |
| | (kg) | (N) | (N) | (MPa) |
| Comparative Sample A | 8 to 10 | 0.25 to 0.5 | 4 to 5 | 800-900 |
| Comparative Sample B | 15 to 40 | 1 to 2 | 10 to 12 | 800-900 |
| Comparative Sample C | >50 | 1 to 2 | 8 to 10 | 800-900 |
| Comparative Sample D | 15 to 20 | 0.5 to 1 | 5 to 7 | 900-1000 |

With reference to Table 4, the glass of Sample 3 was produced commercially by the fusion downdraw process and glass plates having dimensions of 50×50×1 mm were cut from the sheets. The glasses were thermally tempered by first homogenizing the temperature of the glass plate at the tempering temperature noted in each row, ex: 650° C., 700° C., 790° C., etc. After homogenization, the glass plate was rapidly and uniformly quenched to room temperature under a sustained cooling of the denoted heat transfer rate (given in cal/(cm²-s)) which results in the thermal tempering stress. Additional details on the thermal tempering process can be found in U.S. Pat. Nos. 10,611,664 and 9,957,190, the contents of each of which are hereby incorporated by reference in their entireties.

Scratch resistance was evaluated using a Knoop diamond indenter. In Knoop scratch threshold testing, a ramped load scratch is performed to identify the lateral crack onset load range for a given glass composition. Once the applicable load range is identified, a series of increasing constant load scratches (3 minimum or more per load) are performed to identify the KST (Knoop scratch threshold). The KST range can be determined by comparing the test specimen to one of the following 3 failure modes: 1) sustained lateral surface cracks that are >2× width of the groove; 2) damage is contained within the groove, but there are lateral surface cracks that are <2× width of groove and there is damage visible by naked eye; or 3) there are large subsurface lateral cracks which are >2× width of groove and/or there is a median crack at the vertex of the scratch.

Vickers indentation fracture threshold (VIFT) is measured by using a Vickers indenter. The Vickers indenter is a square based diamond pyramid having four faces, with the included angle between opposite faces of 136°. The technique (see, e.g., D. J. Morris, S. B. Myers, and R. F. Cook, “Indentation crack initiation in ion-exchanged aluminosilicate glass,” 39 J. MAT. SCI. 2399-2410 (2004), herein incorporated by reference in its entirety) involves making multiple indentations with a Vickers indenter at a constant load. VIFT measurements described herein are performed by applying and then removing an indentation load to the glass surface at a rate of 0.2 mm/min wherein the indentation load is held for 10 seconds and the maximum load. All indentation measurements are performed at room temperature in 50% relative humidity. Each indentation has the potential to produce 4 radial cracks, one from each corner of the indent. The VIFT is defined by counting the average number of radial cracks at each indentation load, and the cracking threshold can be defined by the load at which there is an average of 2 cracks per indent (or the 50% cracking threshold), reported in kilograms (kg). at the indentation load at which 50% of indents at a load exhibit any number of radial/median cracks emanating from the corners of the indent impression, and is reported in kilograms (kg). The maximum load is increased until the threshold (VIFT) is met for a given glass composition.

Scratch resistance was also evaluated using a Vicker's diamond indenter. In Vicker's scratch threshold testing, a ramped load scratch is performed to identify the lateral crack onset load range for a given glass composition. Once the applicable load range is identified, a series of increasing constant load scratches (3 minimum or more per load) are performed to identify the VST (Vicker's scratch threshold). The VST range can be determined by comparing the test specimen to one of the following 3 failure modes: 1) sustained lateral surface cracks that are >2× width of the groove; 2) damage is contained within the groove, but there are lateral surface cracks that are <2× width of groove and there is damage visible by naked eye; or 3) there are large subsurface lateral cracks which are >2× width of groove and/or there is a median crack at the vertex of the scratch.

As shown in Table 4, in addition to forming a deep compression during thermal tempering (approximately 20-25% of the total plate thickness), the surface fictive temperature of the glass article increases due to the rapid quench. In particular, without being bound by theory, the higher fictive temperature material has a more open micro-structure, and, as a result, becomes more capable of accommodating densification upon indentation and scratching events, which in turn results in a higher load required to induce cracking. As compared to lithium-containing glasses that are ion-exchanged (Table 5), Sample 3 exhibited less compressive stress, but improved scratch and indentation performance.

Various embodiments described herein enable strengthened glass materials to be used in mobile devices suitable for 5G communications, with improved transmission and dielectric permeability across wavelengths from 20 GHz to 100 GHz, and specifically at the 5G operating frequencies of 28 GHz and 38 GHz. The low dielectric constant and low loss tangent of the strengthened glass articles of various embodiments can improve transmission and reception of data signals. Additionally, in various embodiments described herein exhibit higher thermal conductivity compared to conventional cover glasses, and can demonstrate improved heat dissipation and mitigation of increasing dielectric losses. Accordingly, various embodiments enable consumer electronics products with enhanced 5G communications because the electromagnetic signals are less attenuated as compared to conventional cover glasses.

It will be apparent to those skilled in the art that various modifications and variations can be made to embodiment of the present disclosure without departing from the spirit and scope of the disclosure. Thus it is intended that the present disclosure cover such modifications and variations provided they come within the scope of the appended claims and their equivalents.

1-20. (canceled)

21. A strengthened glass article formed from a glass composition comprising less than 1.0 mol % R₂O, where R is an alkali ion, wherein the strengthened glass article has a dielectric constant of less than 6.25 and a dielectric loss tangent of less than 0.01 at 30 GHz.

22. The strengthened glass article according to claim 21, wherein the strengthened glass article has a thermal conductivity of from 1.0 to 1.5 W/m*K at 25° C.

23. The strengthened glass article according to claim 21, wherein the strengthened glass article has a dielectric constant of from 2 to 6 at 30 GHz.

24. The strengthened glass article according to claim 21, wherein the strengthened glass article has a dielectric loss tangent of from 0.0001 to 0.01 at 30 GHz.

25. The strengthened glass article according to claim 21, wherein the glass composition is selected from the group consisting of a silicate glass composition, a borate glass composition, a phosphate glass composition, an aluminate glass composition, a germanate glass composition, and combinations thereof.

26. The strengthened glass article according to claim 21, wherein the glass composition comprises less than 0.1 mol % R₂O.

27. The strengthened glass article according to claim 21, wherein the glass composition is free of alkali ions.

28. The strengthened glass article according to claim 21, wherein the glass article is strengthened by thermal tempering or mechanical strengthening.

29. An electronic device comprising the strengthened glass article according to claim 21.

30. The electronic device according to claim 29, wherein the strengthened glass article is positioned directly adjacent to at least one wave layer having a dielectric constant that is less than the dielectric constant of the strengthened glass article.

31. A consumer electronic product, comprising:
a housing comprising a front surface, a back surface, and side surfaces;
electrical components at least partially within the housing, the electrical components comprising a controller, a memory, and a display, the display at or adjacent the front surface of the housing; and
a cover substrate disposed over the display,
wherein at least one of a portion of the housing or the cover substrate comprises the strengthened glass article of claim 21.

32. The consumer electronic product of claim 31, wherein a portion of the housing comprises the strengthened glass article, and wherein the strengthened glass article comprises a region with a smaller thickness d₁ that is less than or equal to about 20% of a thickness of a remainder of the strengthened glass article d.

33. A method of forming a strengthened glass article comprising:
forming a glass article from a glass composition comprising less than 1.0 mol % R₂O, where R is an alkali ion; and
strengthening the glass article using a thermal tempering or mechanical strengthening process, thereby forming the strengthened glass article, wherein the strengthened glass article has a dielectric constant of less than 6.25 and a dielectric loss tangent of less than 0.01 at 30 GHz.

34. The method according to claim 33, wherein the strengthened glass article has a thermal conductivity of from 1.0 to 1.5 W/m*K at 25° C.

35. The method according to claim 33, wherein the strengthened glass article has a dielectric constant of from 2 to 6 at 30 GHz.

36. The method according to claim 33, wherein the strengthened glass article has a dielectric loss tangent of from 0.0001 to 0.01 at 30 GHz.

37. The method according to claim 33, wherein the glass composition is selected from the group consisting of a silicate glass composition, a borate glass composition, a phosphate glass composition, an aluminate glass composition, a germanate glass composition, and combinations thereof.

38. The method according to claim 33, wherein the glass composition is free of alkali ions.

39. The method according to claim 33, wherein the glass composition comprises less than 5 mol % [MgO+CaO].

40. The method according to claim 33, wherein the strengthened glass article is positioned directly adjacent to and in contact with at least one wave layer having a dielectric constant less than the dielectric constant of the strengthened glass article.
